(19) United States
(12) Patent Application Publication
(10) Pub. No.: US 2006/0019853 A1
(43) Pub. Date: Jan. 26, 2006

(54) Use of metal complex compounds as catalysts for oxidation using molecular oxygen or air

(76) Inventors: Torsten Wieprecht, Schopfheim (DE); Gunther Schlingloff, Riehen (CH); Juntao Xia, Shanghai (CN); Uwe Heinz, Saarlouis (DE); Abert Schneider, Grenzach-Wyhlen (DE); Marie-Josee Dubs, Wittersdorf (FR); Frank Bachmann, Freiburg (DE); Menno Hazekamp, Riehen (CH); Josef Dannacher, Basel (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/531,907

(22) PCT Filed: Oct. 21, 2003
(86) PCT No.: PCT/EP03/11635

§ 371 Date: Apr. 18, 2005

(30) Foreign Application Priority Data
Oct. 29, 2002 (EP) 02405922.2

(51) Int. Cl. C07F 15/00; C11D 3/28

(52) U.S. Cl. 510/367; 546/2

(57) ABSTRACT

Use, as a catalyst for oxidation reactions using molecular oxygen and/or air, of at least one metal complex compound of formula (1) wherein Me is manganese, titanium, iron, cobalt, nickel or copper, X is a coordinating or bridging radical, n and m are each independently of the other an integer having a value of from 1 to 8, p is an integer having a value of from 0 to 32, z is the charge of the metal complex, Y is a counter-ion, q=z/(charge of Y), and L is a ligand of formula (2) wherein R₁, R₂, R₃, R₄, R₅, R₆, R₇, R₈, R₉, R₁₀ and R₁₁ are each independently of the others hydrogen; unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; —SR₁₃, —SO₂R₁₃ or —OR₁₃ wherein R₁₃ is in each case hydrogen or unsubstituted or substituted C₁-C₁₈alkyl or aryl; —NR₁₄R₁₅; —(C₁-C₆alkylene)-NR₁₄R₁₅; —N⁽⁺⁾R₁₄R₁₅R₁₆; —(C₁-C₆alkylene)-N⁽⁺⁾R₁₄R₁₅R₁₆; —N(R₁₃)—(C₁-C₆alkylene)-NR₁₄R₁₅; —N[(C₁-C₆alkylene)-NR₁₄R₁₅]₂; —N(R₁₃)—(C₁-C₆alkylene)-N⁽⁺⁾R₁₄R₁₅R₁₆; —N[(C₁-C₆alkylene)-N⁽⁺⁾R₁₄R₁₅R_{16]2}; —N(R₁₃)—N—R₁₄R₁₅ or —N(R₁₃)N″R₁₄R₁₅R₁₆, wherein R₁₃ is as defined above and R₁₄, R₁₅ and R₁₆ are each independently of the other(s) hydrogen or unsubstituted or substituted C₁-C₁₈alkyl or aryl, or R₁₄ and R₁₅, together with the nitrogen atom linking them, form an unsubstituted or substituted 5-, 6- or 7-membered ring which may contain further hetero atoms.
[LₙMeₘXₚ]^{z}Y_{q} (1)

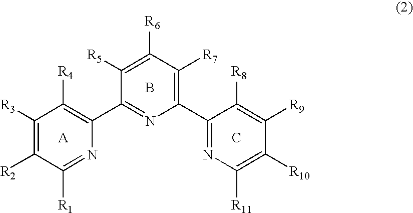

The present invention relates to the use of metal complex compounds having terpyridine ligands as oxidation catalysts for oxidation processes using molecular oxygen and/or air and also to formulations comprising such metal complex compounds.

The metal complex compounds are used especially for bleaching various substrates, for example in the treatment of stains on textile material, without at the same time causing any appreciable damage to fibres and dyeings.

Traditionally, peroxide-containing bleaching agents have been used in washing and cleaning processes. They have an excellent action at a liquor temperature of 90° C. and above, but their performance noticeably decreases with lower temperatures. Currently, peracid precursors are used to activate peroxide-containing bleaching agents. Tetraacetyl ethylene-diamine is mainly used as the activator in European washing systems. US systems, on the other hand, are frequently based on sodium nonanoylbenzosulfonate (Na—NOBS). Activator systems are effective in general, but possess a number of disadvantages. Inter alia, activators must be used in stoichiometric amounts. Large quantities are therefore required and the bleaching components take up a great deal of space in the detergent. In addition, the bleaching action of currently customary activators is often inadequate under certain but desirable washing conditions (e.g. low temperature, short wash cycle).

It is known that, in addition to bleach activators, some transition metal complexes are capable of activating hydrogen peroxide and thus accelerating bleaching processes.

In respect of H₂O₂ activation having effective bleaching action, mononuclear and polynuclear variants of manganese complexes with various ligands, especially 1,4,7-trimethyl-1,4,7-triazacyclononane and optionally oxygen-containing bridge ligands, are currently regarded as being especially effective. Such catalysts have adequate stability under practical conditions and, with Mnⁿ⁺, contain an ecologically acceptable metal cation, but their use is unfortunately associated with considerable damage to dyes and fibres.

Another approach pursues the activation of molecular oxygen of the air by means of transition metal complexes for oxidation processes.

WO00/60043 describes ethylenediamine derivatives as transition metal complexes in bleaching processes that use atmospheric oxygen, e.g. in bleaching stains on laundry. WO01/16272 describes triazocycloalkyl compounds, especially triazacyclononane derivatives, as transition metal complexes in bleaching processes that use atmospheric oxygen, e.g. in bleaching stains on laundry.

In U.S. Pat. No. 6,245,115 B1, specific transition metal complexes are used during washing or in stain treatment, but their action is for the most part not evident until after the process.

In the present invention, it has now, surprisingly, been found that metal complexes with selected terpyridine ligands are capable of acting as catalysts in oxidation processes that use molecular oxygen and/or air in various fields of use. The advantage of those compounds is that, in use, they have a catalytic action and can therefore be used in small amounts. In addition, neither an activator component nor a peroxide component is required, which is advantageous in terms of the environmental properties.

The invention accordingly relates to the use, as catalysts for oxidation reactions using molecular oxygen and/or air, of at least one metal complex of formula (1)
[LₙMeₘXₚ]^{z}Y_{q} (1),
wherein Me is manganese, titanium, iron, cobalt, nickel or copper,
X is a coordinating or bridging radical,
n and m are each independently of the other an integer having a value of from 1 to 8,
p is an integer having a value of from 0 to 32,
z is the charge of the metal complex,
Y is a counter-ion,
q=z/(charge of Y), and
L is a ligand of formula (2) 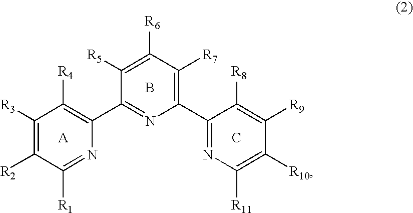
   wherein
R₁, R₂, R₃, R₄, R₅, R₆, R₇, R₈, R₉, R₁₀ and R₁₁ are each independently of the others hydrogen;
unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; —SR₁₃, —SO₂R₁₃ or OR₁₃ wherein R₁₃ is in each case hydrogen or unsubstituted or substituted C₁-C₁₈alkyl or aryl; —NR₁₄R₁₅; —(C₁-C₆alkylene)-NR₁₄R₁₅;
—N^{⊕}R₁₄R₁₅R₁₆; —(C₁-C₆alkylene)-N^{⊕}R₁₄R₁₅R₁₆; —N(R₁₃)—(C₁-C₆alkylene)-NR₁₄R₁₅;
—N[(C₁-C₆alkylene)-NR₁₄R₁₅]₂; —N(R₁₃)—(C₁-C₆alkylene)-N^{⊕}R₁₄R₁₅R₁₆;
—N[(C₁-C₆alkylene)-N^{⊕}R₁₄R₁₅R₁₆]₂; —N(R₁₃)—N—R₁₄R₁₅ or —N(R₁₃)—N^{⊕}R₁₄R₁₅R₁₆, wherein R₁₃ is as defined above and R₁₄, R₁₅ and R₁₆ are each independently of the other(s) hydrogen or unsubstituted or substituted C₁-C₁₈alkyl or aryl, or R₁₄ and R₁₅, together with the nitrogen atom linking them, form an unsubstituted or substituted 5-, 6- or 7-membered ring which may contain further hetero atoms.

The C₁₋₆alkylen moieties can be substituted.

The alkyl and alkylene moieties can be lineaer or branched.

Suitable substituents for the alkyl groups, aryl groups, alkylene groups or 5-, 6- or 7-membered rings are especially C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino; phenyl; phenoxy or naphthyloxy.

Generally, halogen is preferably chlorine, bromine or fluorine, with special preference being given to chlorine.

Suitable metal ions for Me are e.g. manganese in oxidation states II-V, titanium in oxidation states III and IV, iron in oxidation states I to IV, cobalt in oxidation states I to III, nickel in oxidation states I to III and copper in oxidation states I to III, with special preference being given to manganese, especially manganese in oxidation states II to IV, preferably in oxidation state II. Also of interest are titanium IV, iron II-IV, cobalt II-III, nickel II-III and copper II-III, especially iron II-IV.

For the radical X there come into consideration, for example, CH₃CN, H₂O, F⁻, Cl⁻, Br⁻, HOO⁻, O₂²⁻, O²⁻, R₁₇COO⁻, R₁₇O⁻, LMeO⁻ and LMeOO⁻, wherein R₁₇ is hydrogen or unsubstituted or substituted C₁-C₁₈alkyl or aryl, and C₁-C₁₈alkyl, aryl, L and Me have the definitions and preferred meanings given hereinabove and hereinbelow. R₁₇ is especially preferably hydrogen, C₁-C₄alkyl or phenyl, especially hydrogen.

As counter-ion Y there come into consideration, for example, R₁₇COO⁻, ClO₄⁻, BF₄⁻, PF₆⁻, R₁₇SO₃⁻, R₁₇SO₄⁻, SO₄²⁻, NO₃⁻, F⁻, Cl⁻, Br⁻ and I⁻, wherein R₁₇ is hydrogen or unsubstituted or substituted C₁-C₁₈alkyl or aryl. R₁₇ as C₁-C₁₈alkyl or aryl has the definitions and preferred meanings given hereinabove and hereinbelow. R₁₇ is especially preferably hydrogen, C₁-C₄alkyl or phenyl, especially hydrogen. The charge of the counter-ion Y is accordingly preferably 1- or 2-, especially 1-.
n is preferably an integer having a value of from 1 to 4, preferably 1 or 2 and especially 1.
m is preferably an integer having a value of 1 or 2, especially 1.
p is preferably an Integer having a value of from 0 to 4, especially 2.
z is preferably an integer having a value of from 8− to 8+, especially from 4− to 4+ and especially preferably from 0 to 4+. z is more especially the number 0.
q is preferably an integer from 0 to 8, especially from 0 to 4 and is especially preferably the number 0.

The C₁-C₁₈alkyl radicals mentioned are generally, for example, straight-chain or branched alkyl radicals, such as methyl, ethyl, n-propyl, isopropyl, n-butyl, sec-butyl, isobutyl, tert-butyl or straight-chain or branched pentyl, hexyl, heptyl or octyl. Preference is given to C₁-C₁₂alkyl radicals, especially C₁-C₈alkyl radicals and preferably C₁-C₄alkyl radicals. The mentioned alkyl radicals may be unsubstituted or substituted e.g. by hydroxy, C₁-C₄alkoxy, sulfo or by sulfato, especially by hydroxy. The corresponding unsubstituted alkyl radicals are preferred. Very special preference is given to methyl and ethyl, especially methyl.

Examples of aryl radicals that generally come into consideration are phenyl or naphthyl each unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy. Preferred substituents are C₁-C₄alkyl, C₁-C₄alkoxy, phenyl and hydroxy. Special preference is given to the corresponding phenyl radicals.

The C₁-C₆alkylene groups mentioned are, for example, straight-chain or branched alkylene radicals, such as methylene, ethylene, n-propylene or n-butylene. C₁-C₄alkylene groups are preferred. The alkylene radicals mentioned may be unsubstituted or substituted, for example by hydroxy or C₁-C₄alkoxy.

Examples of cations that generally come into consideration are alkali metal cations, such as lithium, potassium and especially sodium, alkaline earth metal cations, such as magnesium and calcium, and ammonium cations. The alkali metal cations, especially sodium, are preferred.

R₁₂ is preferably hydrogen, a cation, C₁-C₁₂alkyl, unsubstituted phenyl or phenyl substituted as indicated above. R₁₂ is especially preferably hydrogen, an alkali metal cation, alkaline earth metal cation or ammonium cation, C₁-C₄alkyl or phenyl, more especially hydrogen or an alkali metal cation, alkaline earth metal cation or ammonium cation.

R₁₃ is preferably hydrogen, C₁-C₁₂alkyl, unsubstituted phenyl or phenyl substituted as indicated above. R₁₃ is especially preferably hydrogen, C₁-C₄alkyl or phenyl, more especially hydrogen or C₁-C₄alkyl, preferably hydrogen.

Examples of the radical of formula —N(R₁₃)—NR₁₄R₁₅ that may be mentioned are —N(CH₃)—NH₂ and, especially, —NH—NH₂. Examples of the radical of formula —OR₁₃ that may be mentioned are hydroxy and C₁-C₄alkoxy, such as methoxy and especially ethoxy. When R₁₄ and R₁₅, together with the nitrogen atom linking them, form a 5, 6 or 7-membered ring, that ring is preferably an unsubstituted or C₁-C₄alkyl-substituted pyrrolidine, piperidine, piperazine, morpholine or azepane ring, wherein the amino groups may be quaternised, in which case preferably the nitrogen atoms that are not bonded directly to one of the three pyridine rings A, B or C are quaternised.

The piperazine ring may, for example, be substituted by one or two unsubstituted C₁-C₄alkyl and/or substituted C₁-C₄alkyl at the nitrogen atom not bonded to the pyridine ring. In addition, R₁₄, R₁₅ and R₁₆ are preferably hydrogen, unsubstituted or hydroxy-substituted C₁-C₁₂alkyl, unsubstituted phenyl or phenyl substituted as indicated above. Special preference is given to hydrogen, C₁-C₄alkyl or phenyl each unsubstituted or hydroxy-substituted, especially hydrogen or unsubstituted or hydroxy-substituted C₁-C₄alkyl, preferably hydrogen.

Examples of the radical of formula —NR₁₄R₁₅ that may be mentioned are —NH₂, —NHCH₂CH₂OH, —N(CH₂CH₂OH)₂, —N(CH₃)CH₂CH₂OH, and the pyrrolidine, piperidine, piperazine, morpholine or azepane ring as well as 4methyl-piperazin-1-yl.

Preference is given to ligands L of formula (2) wherein R₆ is not hydrogen.

Preference is given likewise to ligands L of formula (2) wherein R₆ is preferably C₁-C₁₂alkyl; phenyl unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy; cyano; halogen; nitro; —COOR₁₂ or —SO₃R₁₂ wherein R₁₂ is in each case hydrogen, a cation, C₁-C₁₂alkyl, unsubstituted phenyl or phenyl substituted as indicated above; —SR₁₃, —SO₂R₁₃ or —OR₁₃ wherein R₁₃ is in each case hydrogen, C₁-C₁₂alkyl, unsubstituted phenyl or phenyl substituted as indicated above; —N(R₁₃)—NR₁₄R₁₅ wherein R₁₃ is as defined above and R₁₄ and R₁₅ are each independently of the other hydrogen, unsubstituted or hydroxy-substituted C₁-C₁₂alkyl, unsubstituted phenyl or phenyl substituted as indicated above, or R₁₄ and R₁₅, together with the nitrogen atom linking them, form an unsubstituted or C₁-C₄alkyl-substituted pyrrolidine, piperidine, piperazine, morpholine or azepane ring; —NR₁₄R₁₅ or —N^{⊕}R₁₄R₁₅R₁₆ wherein R₁₄, R₁₅ and R₁₆ are each independently of the other(s) hydrogen, unsubstituted or hydroxy-substituted C₁-C₁₂alkyl, unsubstituted phenyl or phenyl substituted as indicated above, or R₁₄ and R₁₅, together with the nitrogen atom linking them, form an unsubstituted or C₁-C₄alkyl-substituted pyrrolidine, piperidine, piperazine, morpholine or azepane ring.

R₆ in L is especially preferably phenyl unsubstituted or substituted by C₁-C₄alkyl, C₁-C₄-alkoxy, halogen, phenyl or by hydroxy; cyano; nitro; —COOR₁₂ or —SO₃R₁₂ wherein R₁₂ is in each case hydrogen, a cation, C₁-C₄alkyl or phenyl; —SR₁₃, —SO₂R₁₃ or —OR₁₃ wherein R₁₃ is in each case hydrogen, C₁-C₄alkyl or phenyl; —N(CH₃)—NH₂ or —NH—NH₂; amino; N-mono- or N,N-di-C₁-C₄alkylamino unsubstituted or substituted by hydroxy in the alkyl moiety; or an unsubstitituted or C₁-C₄alkyl-substituted pyrrolidine, piperidine, piperazine, morpholine or azepane ring.

R₆ in L is very especially C₁-C₄alkoxy; hydroxy; phenyl unsubstituted or substituted by C₁-C₄alkyl, C₁-C₄alkoxy, phenyl or by hydroxy; hydrazine; amino; N-mono- or N,N-di-C₁-C₄-alkylamino unsubstituted or substituted by hydroxy in the alkyl moiety; or an unsubstitituted or C₁-C₄alkyl-substituted pyrrolidine, piperidine, piperazine, morpholine or azepane ring.

Radicals R₆ in L that are especially important are C₁-C₄alkoxy; hydroxy; hydrazine; amino; N-mono- or N,N-di-C₁-C₄alkylamino unsubstituted or substituted by hydroxy in the alkyl moiety; or an unsubstitituted or C₁-C₄alkyl-substituted pyrrolidine, piperidine, piperazine, morpholine or azepane ring.

Radicals R₆ in L that are very especially important are C₁-C₄alkoxy; hydroxy; N-mono- or N,N-di-C₁-C₄alkylamino unsubstituted or substituted by hydroxy in the alkyl moiety; or an unsubstitituted or C₁-C₄alkyl-substituted pyrrolidine, piperidine, piperazine, morpholine or azepane ring. Of those, hydroxy is of special interest.

The preferred meanings indicated above for R₆ apply to R₁, R₂, R₃, R₄, R₅, R₇, R₈, R₉, R₁₀ and R₁₁ in L, but those radicals may additionally be hydrogen.

According to one embodiment of the present invention, R₁, R₂, R₃, R₄, R₅, R₇, R₈, R₉, R₁₀ and R₁₁ in L are hydrogen and R₆ in L Is a radical other than hydrogen, for which the definition and preferred meanings indicated above apply.

According to a further embodiment of the present invention, R₁, R₂, R₄, R₅, R₇, R₈, R₁₀ and R₁₁ in L are hydrogen and R₃, R₆ and R₉ in L are radicals other than hydrogen, for each of which the definition and preferred meanings indicated above for R₆ apply.

Ligands L to which preference is given are those of formula (3) 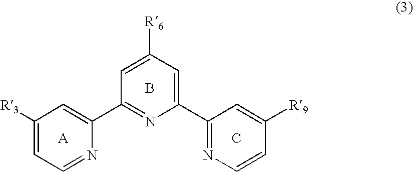
wherein R′₃ and R′₉ have the definitions and preferred meanings indicated above for R₃ and R₉ and R′₆ has the definition and preferred meanings indicated above for R₆.

Ligands L to which greater preference is given are those of formula (3) 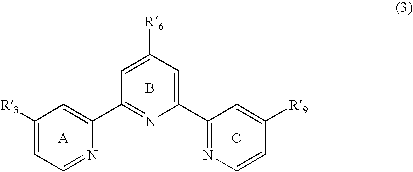
wherein R′₃, R′₆ and R′₉ are each independently of the others C₁₋₄alkoxy; hydroxy; phenyl unsubstituted or substituted by C₁-C₄alkyl, C₁-C₄alkoxy, phenyl or by hydroxy, hydrazine; amino; N-mono- or N,N-di-C₁-C₄alkylamino unsubstituted or substituted by hydroxy in the alkyl moiety; or an unsubstituted or C₁₋₄alkyl-substituted pyrrolidine, piperidine, piperazine, morpholine or azepane ring.

An embodiment of the invention to which preference is likewise given is the use, as catalysts for oxidation reactions using molecular oxygen and/or air, of at least one metal complex compound of formula (1′)
[L′ₙMeₘXₚ]^{z}Y_{q} (1′),
wherein
Me is manganese, titanium, iron, cobalt, nickel or copper,
X is a coordinating or bridging radical,
n and m are each independently of the other an integer having a value of from 1 to 8,
p is an integer having a value of from 0 to 32,
z is the charge of the metal complex,
Y is a counter-ion,
q=z/(charge of Y), and
L′ is a ligand of formula (2′) 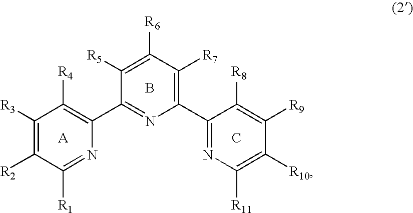
   wherein
R₁, R₂, R₃, R₄, R₅, R₆, R₇, R₈, R₉, R₁₀ and R₁₁ are each independently of the others hydrogen;
unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; —SR₁₃, —SO₂R₁₃ or —OR₁₃ wherein R₁₃ is in each case hydrogen or unsubstituted or substituted C₁-C₁₈alkyl or aryl; —NR₁₄R₁₅; —(C₁-C₆alkylene)-NR₁₄R₁₅;
—N^{⊕}R₁₄R₁₅R₁₆; —(C₁-C₆alkylene)-N^{⊕}R₁₄R₁₅R₁₆; —N(R₁₃)—(C₁-C₆alkylene)-NR₁₄R₁₅;
—N[(C₁-C₆alkylene)-NR₁₄R₁₅]₂; —N(R₁₃)—(C₁-C₆alkylene)-N^{⊕}R₁₄R₁₅R₁₆;
—N[(C₁-C₆alkylene)-N^{⊕}R₁₄R₁₅R₁₆]₂; —N(R₁₃)—N—R₁₄R₁₅ or —N(R₁₃)—N^{⊕}R₁₄R₁₅R₁₆, wherein R₁₃ is as defined above and R₁₄, R₁₅ and R₁₆ are each independently of the other(s) hydrogen or unsubstituted or substituted C₁-C₁₈alkyl or aryl, or R₁₄ and R₁₅, together with the nitrogen atom linking them, form an unsubstituted or substituted 5-, 6 or 7-membered ring which may contain further hetero atoms, with the proviso that at least one of the substituents R₁ to R₁₁ is a quaternised nitrogen atom that is not bonded directly to one of the three pyridine rings A, B or C.

Suitable substituents for the alkyl groups, aryl groups, alkylene groups or 5-, 6 or 7-membered rings are especially C₁-C₄alkyl; C₁-C₄alkoxy; hydroxy; sulfo; sulfato; halogen; cyano; nitro; carboxy, amino; N-mono- or N,N-di-C₁-C₄alkylamino unsubstituted or substituted by hydroxy in the alkyl moiety; N-phenylamino; N-naphthylamino; phenyl; phenoxy or naphthyloxy.

Suitable metal ions for Me for the compounds of formula (1′) are, for example, manganese in oxidation states II-V, titanium in oxidation states III and IV, iron in oxidation states I to IV, cobalt in oxidation states I to III, nickel in oxidation states I to III and copper in oxidation states I to III, with special preference being given to manganese, especially manganese in oxidation states II to IV, preferably in oxidation state II. Also of interest are titanium IV, iron II-IV, cobalt II-III, nickel II-III and copper II-III, especially iron II-IV.

For the radical X for the compounds of formula (1′) there come into consideration, for example, CH₃CN, H₂O, F⁻, Cl⁻, Br⁻, HOO⁻, O₂²⁻, O²⁻, R₁₇COO⁻, R₁₇O⁻, LMeO⁻ and LMeOO⁻, wherein R₁₇ is hydrogen or unsubstituted or substituted C₁-C₁₈alkyl or aryl, and C₁-C₁₈alkyl, aryl, L and Me have the definitions and preferred meanings given hereinabove and hereinbelow. R₁₇ is especially preferably hydrogen, C₁-C₄alkyl or phenyl, especially hydrogen.

As counter-ion Y for the compounds of formula (1′) there come into consideration, for example, R₁₇COO⁻, ClO₄⁻, BF₄⁻, PF₆⁻, R₁₇SO₃⁻, R₁₇SO₄⁻, SO₄²⁻, NO₃⁻, F⁻, Cl⁻, Br⁻ and I⁻, wherein R₁₇ is hydrogen or unsubstituted or substituted C₁-C₁₈alkyl or aryl. R₁₇ as C₁-C₁₈alkyl or aryl has the definitions and preferred meanings given hereinabove and hereinbelow. R₁₇ is especially preferably hydrogen, C₁-C₄alkyl or phenyl, especially hydrogen. The charge of the counter-ion Y is accordingly preferably 1- or 2-, especially 1-.

For the compounds of formula (1′), n is preferably an integer having a value of from 1 to 4, preferably 1 or 2 and especially 1.

For the compounds of formula (1′), m is preferably an integer having a value of 1 or 2, especially 1.

For the compounds of formula (1′), p is preferably an integer having a value of from 0 to 4, especially 2.

For the compounds of formula (1′), z is preferably an integer having a value of from 8− to 8+, especially from 4− to 4+ and especially preferably from 0 to 4+. z is more especially the number 0.

For the compounds of formula (1′), q is preferably an integer from 0 to 8, especially from 0 to 4, and is especially preferably the number 0.

The C₁-C₁₈alkyl radicals mentioned for the compounds of formula (2′) are, for example, straight-chain or branched alkyl radicals, such as methyl, ethyl, n-propyl, isopropyl, n-butyl, sec-butyl, isobutyl, tert-butyl or straight-chain or branched pentyl, hexyl, heptyl or octyl. Preference is given to C₁-C₁₂alkyl radicals, especially C₁-C₈alkyl radicals and preferably C₁-C₄alkyl radicals. The mentioned alkyl radicals may be unsubstituted or substituted, for example by hydroxy, C₁-C₄alkoxy, sulfo or sulfato, especially by hydroxy. The corresponding unsubstituted alkyl radicals are preferred. Very special preference is given to methyl and ethyl, especially methyl.

Examples of aryl radicals that come into consideration for the compounds of formula (2′) are phenyl or naphthyl each unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthyl-amino, phenyl, phenoxy or by naphthyloxy. Preferred substituents are C₁-C₄alkyl, C₁-C₄alkoxy, phenyl and hydroxy.

Special preference is given to the corresponding phenyl radicals.

The C₁-C₆alkylene groups mentioned for the compounds of formula (2′) are, for example, straight-chain or branched alkylene radicals, such as methylene, ethylene, n-propylene or n-butylene. C₁-C₄alkylene groups are preferred. The alkylene radicals mentioned may be unsubstituted or substituted, for example by hydroxy or C₁-C₄alkoxy.

Halogen for the compounds of formulae (1′) and (2′) is preferably chlorine, bromine or fluorine, with special preference being given to chlorine.

Examples of cations that come into consideration for the compounds of formulae (1′) and (2′) are alkali metal cations, such as lithium, potassium and especially sodium, alkaline earth metal cations, such as magnesium and calcium, and ammonium cations. The alkali metal cations, especially sodium, are preferred.

R₁₂ in compounds of formula (2′) is preferably hydrogen, a cation, C₁-C₁₂alkyl, unsubstituted phenyl or phenyl substituted as indicated above. R₁₂ is especially preferably hydrogen, an alkali metal cation, alkaline earth metal cation or ammonium cation, C₁-C₄alkyl or phenyl, more especially hydrogen or an alkali metal cation, alkaline earth metal cation or ammonium cation.

R₁₃ in compounds of formula (2′) is preferably hydrogen, C₁-C₁₂alkyl, unsubstituted phenyl or phenyl substituted as indicated above. R₁₃ is especially preferably hydrogen, C₁-C₄alkyl or phenyl, more especially hydrogen or C₁-C₄alkyl, preferably hydrogen.

Examples of the radical of formula —N(R₁₃)—NR₁₄R₁₅ that may be mentioned are —N(CH₃)—NH₂ and, especially, —NH—NH₂. Examples of the radical of formula —OR₁₃ that may be mentioned are hydroxy and C₁-C₄alkoxy, such as methoxy and especially ethoxy.

When R₁₄ and R₁₅, together with the nitrogen atom linking them, form a 5-, 6- or 7-membered ring, that ring is preferably an unsubstituted or C₁-C₄alkyl-substituted pyrrolidine, piperidine, piperazine, morpholine or azepane ring, wherein the amino groups may be quaternised, in which case preferably the nitrogen atoms that are not bonded directly to one of the three pyridine rings A, B or C are quaternised.

The piperazine ring may, for example, be substituted by one or two unsubstituted C₁-C₄alkyl and/or substituted C₁-C₄alkyl at the nitrogen atom not bonded to the pyridine ring. In addition, R₁₄, R₁₅ and R₁₆ are preferably hydrogen, unsubstituted or hydroxy-substituted C₁-C₁₂alkyl, unsubstituted phenyl or phenyl substituted as indicated above. Special preference is given to hydrogen, unsubstituted or hydroxy-substituted C₁-C₄alkyl or phenyl, especially hydrogen or unsubstituted or hydroxy-substituted C₁-C₄alkyl, preferably hydrogen. Examples of the radical of formula —NR₁₄R₁₅ that may be mentioned are —NH₂, —NHCH₂CH₂OH, —N(CH₂CH₂OH)₂, —N(CH₃)CH₂CH₂OH, and the pyrrolidine, piperidine, piperazine, morpholine or azepane ring as well as 4methyl-piperazin-1-yl.

Preference is given to ligands L′ of formula (2′), wherein R₆ is preferably phenyl unsubstituted or substituted by C₁-C₄alkyl, C₁-C₄alkoxy, halogen, phenyl or by hydroxy; cyano; nitro; —COOR₁₂ or —SO₃R₁₂ wherein R₁₂ is in each case hydrogen, a cation, C₁-C₄alkyl or phenyl; —SR₁₃, —SO₂R₁₃ or —OR₁₃ wherein R₁₃ is in each case hydrogen, C₁-C₄alkyl or phenyl; —N(CH₃)—NH₂ or —NH—NH₂; amino; N-mono- or N,N-di-C₁-C₄alkylamino unsubstituted or substituted by hydroxy in the alkyl moiety, wherein the nitrogen atoms, especially the nitrogen atoms not bonded to one of the three pyridine rings A, B or C, may be quaternised; N-mono- or N,N-di-C₁-C₄alkyl-N^{⊕}R₁₄R₁₅R₁₆ unsubstituted or substituted by hydroxy in the alkyl moiety, wherein R₁₄, R₁₅ and R₁₆ are each independently of the others hydrogen, unsubstituted or hydroxy-substituted C₁-C₁₂alkyl, unsubstituted phenyl or phenyl substituted as indicated above, or R₁₄ and R₁₅, together with the nitrogen atom linking them, form a pyrrolidine, piperidine, piperazine, morpholine or azepane ring which is unsubstituted or substituted by at least one C₁-C₄alkyl or by at least one unsubstituted C₁-C₄alkyl and/or substituted C₁-C₄alkyl, wherein the nitrogen atom may be quaternised; N-mono- or N,N-di-C₁-C₄alkyl-NR₁₄R₁₅ unsubstituted or substituted by hydroxy in the alkyl moiety, wherein R₁₄ and R₁₅ may have any one of the above meanings.

R₆ in L′ of formula (2′) is very especially C₁-C₄alkoxy; hydroxy; phenyl unsubstituted or substituted by C₁-C₄alkyl, C₁-C₄alkoxy, phenyl or by hydroxy; hydrazine; amino; N-mono- or N,N-di-C₁-C₄alkylamino unsubstituted or substituted by hydroxy in the alkyl moiety, wherein the nitrogen atoms, especially the nitrogen atoms that are not bonded to one of the three pyridine rings A, B or C, may be quaternised; or a pyrrolidine, piperidine, morpholine or azepane ring unsubstituted or substituted by one or two unsubstituted C₁-C₄alkyl and/or substituted C₁-C₄alkyl, wherein the nitrogen atom may be quaternised.

A likewise very especially preferred radical that may be mentioned for R₆ is 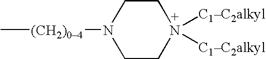
wherein the ring and the two alkyl groups may additionally be substituted.

Especially important as radicals R₆ in L′ of formula (2′) are C₁-C₄alkoxy; hydroxy, N-mono- or N,N-di-C₁-C₄alkylamino unsubstituted or substituted by hydroxy in the alkyl moiety, wherein the nitrogen atoms, especially the nitrogen atoms that are not bonded to one of the three pyridine rings A, B or C, may be quaternised; or a pyrrolidine, piperidine, piperazine, morpholine or azepane ring unsubstituted or substituted by at least one C₁-C₄alkyl, wherein the amino groups may be quaternised.

As examples of the radicals R₆ in L′ of formula (2′), mention may be made especially of —OH;

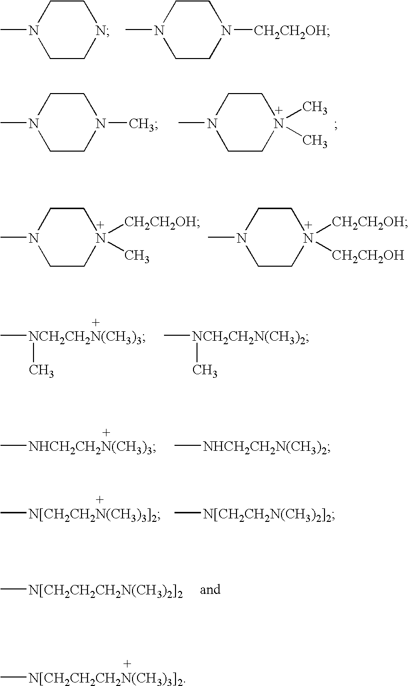

Of those, hydroxy is of special interest.

The preferred meanings given above for R₆ in L′ of formula (2′) apply also to R₁, R₂, R₃, R₄, R₅, R₇, R₈, R₉, R₁₀ and R₁₁ in L′ of formula (2′), but those radicals may additionally be hydrogen.

In accordance with one embodiment of the present invention, R₁, R₂, R₃, R₄, R₅, R₇, R₈, R₉, R₁₀ and R₁₁ in L′ of formula (2′) are hydrogen and R₆ in L′ of formula (2′) is a radical other than hydrogen having the definition and preferred meanings indicated above.

In accordance with a further embodiment of the present invention, R₁, R₂, R₄, R₅, R₇, R₈, R₁₀ and R₁₁ in L′ of formula (2′) are hydrogen and R₃, R₆ and R₉ in L′ of formula (2) are radicals other than hydrogen having the definitions and preferred meanings indicated above for R₆.

In a likewise preferred use according to the invention of at least one metal complex compound of formula (1′), at least one of the substituents R₁ to R₁₁ in L′, preferably R₃, R₆ and/or R₉, is one of the following radicals: —(C₁-C₆alkylene)-N^{⊕}R₁₄R₁₅R₁₆; —N(R₁₃)—(C₁-C₆-alkylene)-N^{⊕}R₁₄R¹⁵R₁₆; —N[(C₁-C₆alkylene)-N^{⊕}R₁₄R₁₅R₁₆]₂; —N(R₁₃)—N^{⊕}R₁₄R₁₅R₁₆, wherein R₁₃ is as defined above and R₁₄, R₁₅ and R₁₆ are each independently of the others hydrogen or unsubstituted or substituted C₁-C₁₈alkyl or aryl, or R₁₄ and R₁₅, together with the nitrogen atom linking them, form an unsubstituted or substituted 5-, 6- or 7-membered ring which may contain further hetero atoms; or —NR₁₄R₁₅; —(C₁-C₆alkylene)-NR₁₄R₁₅; —N(R₁₃)—(C₁-C₆alkylene)-NR₁₄R₁₅; —N[(C₁-C₆alkylene)-NR₁₄R₁₅]₂; —N(R₁₃)—N—R₁₄R₁₅ wherein R₁₃ haS the meanings indicated above and R₁₄ and R₁₅, together with the nitrogen atom linking them, form a 5-, 6- or 7-membered ring which is unsubstituted or substituted by at least one unsubstituted C₁-C₄alkyl and/or substituted C₁-C₄alkyl and may contain further hetero atoms, wherein at least one nitrogen atom not bonded to one of the pyridine rings A, B or C is quaternised.

In a likewise more preferred use according to the invention of at least one metal complex compound of formula (1′), at least one of the substituents R₁ to R₁₁ in L′, preferably R₃, R₆ and/or R₉, is one of the following radicals: —(C₁-C₄alkylene)-N^{⊕}R₁₄R₁₅R₁₆; —N(R₁₃)—(C₁-C₄-alkylene)-N^{⊕}R₁₄R₁₅R₁₆; —N[(C₁-C₄alkylene)-N^{⊕}R₁₄R₁₅R₁₆]₂; —N(R₁₃)—N^{⊕}R₁₄R₁₅R₁₆, wherein R₁₃ is hydrogen, unsubstituted or substituted C₁-C₁₂alkyl or aryl and R₁₄, R₁₅ and R₁₆ are each independently of the others hydrogen or unsubstituted or substituted C₁-C₁₂alkyl or aryl, or R₁₄ and R₁₅, together with the nitrogen atom linking them, form a 5-, 6- or 7-membered ring which is unsubstituted or substituted by at least one unsubstituted C₁-C₄alkyl and/or substituted C₁-C₄alkyl and may contain further hetero atoms; or —NR₁₄R₁₅; —(C₁-C₄alkylene)-NR₁₄R₁₅; —N(R₁₃)—(C₁-C₄alkylene)-NR₁₄R₁₅; —N[(C₁-C₄alkylene)-NR₁₄R₁₅]₂; —N(R₁₃)—N—R₁₄R₁₅, wherein R₁₃ and R₁₆ are each independently of the other hydrogen, unsubstituted or substituted C₁-C₁₂alkyl or aryl and R₁₄ and R₁₅, together with the nitrogen atom linking them, form an unsubstituted or substituted 5-, 6- or 7-membered ring which may contain further hetero atoms, wherein at least one nitrogen atom not bonded to one of the pyridine rings A, B or C is quaternised.

In a likewise important use according to the invention of at least one metal complex compound of formula (1′), at least one of the substituents R₁₀ to R₁₁ in L′, preferably R₃, R₆ and/or R₉, is a radical 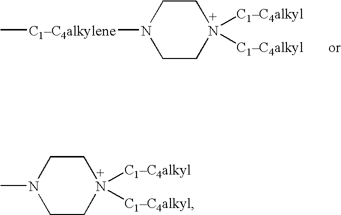
wherein the unbranched or branched alkylene group may be unsubstituted or substituted and wherein the alkyl groups, which are unbranched or branched independently of one another, may be unsubstituted or substituted.

The piperazine ring may also be unsubstituted or substituted.

In a likewise especially important use according to the invention of at least one metal complex compound of formula (1′), at least one of the substituents R₁ to R₁₁ in L′, preferably R₃, R₆ and/or R₉, is a radical 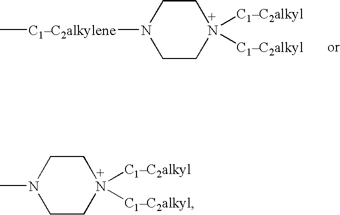
wherein the unbranched or branched alkylene group may be unsubstituted or substituted and wherein the alkyl groups, each independently of the other, may be unsubstituted or substituted.

The piperazine ring may also be unsubstituted or substituted.

Ligands L′ to which preference is given are those of formula (3′) 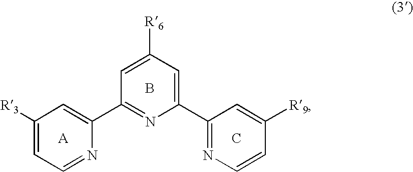
wherein R′₃, R′₆ and R′₉ have the definitions and preferred meanings indicated above for R₆, but R′₃ and R′₉ may additionally be hydrogen.

Ligands L′ to which greater preference is given are those of formula (3′) 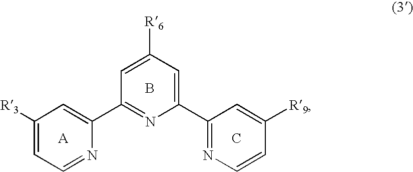
wherein R′₃, R′₆ and R′₉ have the definitions and preferred meanings indicated above for R₆, but R′₃ and R′₉ may additionally be hydrogen, with the proviso that
(i) at least one of the substituents R′₃, R′₆ and R′₉ is a radical —(C₁-C₆alkylene)-N^{⊕}R₁₄R₁₅R₁₆; —N(R₁₃)—(C₁-C₆alkylene)-N^{⊕}R₁₄R₁₅R₁₆; —N[(C₁-C₆alkylene)-N^{⊕}R₁₄R₁₅R₁₆]₂; —N(R₁₃)—N^{⊕}R₁₄R₁₅R₁₆, wherein R₁₃ is as defined above and R₁₄, R₁₅ and R₁₆ are each independently of the others hydrogen or unsubstituted or substituted C₁-C₁₈alkyl or aryl, or R₁₄ and R₁₅, together with the nitrogen atom linking them, form an unsubstituted or substituted 5-, 6- or 7-membered ring which may contain further hetero atoms; or —NR₁₄R₁₅; —(C₁-C₆alkylene)-NR₁₄R₁₅; —N(R₁₃)—(C₁-C₆alkylene)-NR₁₄R₁₅; —N[(C₁-C₆alkylene)-NR₁₄R₁₅]₂; —N(R₁₃)—N—R₁₄R₁₅, wherein R₁₃ haS the meanings indicated above and R₁₄ and R₁₅, together with the nitrogen atom linking them, form a 5-, 6- or 7-membered ring which may be unsubstituted or substituted by at least one unsubstituted C₁-C₄alkyl and/or substituted C₁-C₄alkyl and may contain further hetero atoms, wherein at least one nitrogen atom not bonded to one of the pyridine rings A, B or C is quaternised.

Ligands L′ to which even greater preference is given are those of formula (3′) 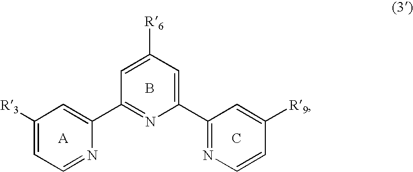
wherein R′₃, R′₆ and R′₉ have the definitions and preferred meanings indicated above for R₆, but R′₃ and R′₉ may additionally be hydrogen, with the proviso that
(i) at least one of the substituents R′₃, R′₆ and R′₉ is one of the radicals 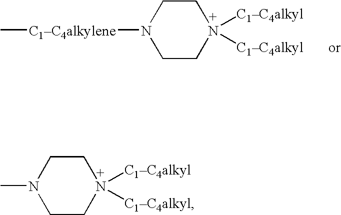
   wherein the unbranched or branched alkylene group may be unsubstituted or substituted, and wherein the alkyl groups, which are branched or unbranched independently of one another, may be unsubstituted or substituted and wherein the piperazine ring may be unsubstituted or substituted.

Ligands L′ to which special preference is given are those of formula (3′) 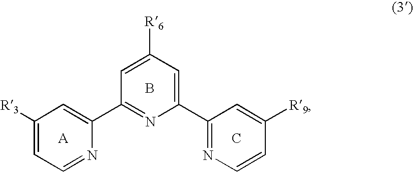
wherein R′₃, R′₆ and R′₉ have the definitions and preferred meanings given above for R₆, but R′₃ and R′₉ may additionally be hydrogen, with the proviso that
(i) at least one of the substituents R′₃, R′₆ and R′₉ is one of the radicals 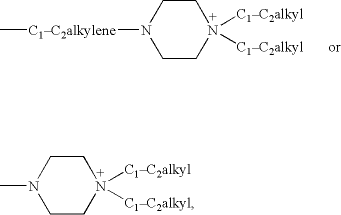
   wherein the unbranched or branched alkylene group may be unsubstituted or substituted and wherein the alkyl groups, which are branched or unbranched independently of one another, may be unsubstituted or substituted and wherein the piperazine ring may be unsubstituted or substituted.

R′₃, R′₆ and/or R′₉ in L′ of formula (2′) may be especially a radical 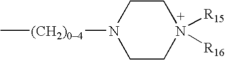
wherein R₁₅ and R₁₆ have the definitions given above and the ring may be unsubstituted or substituted.

In L′ , R′₃ and R′₉ may likewise additionally be hydrogen.

Preferred as L′ of formulae (2) and (2′) are compounds in which precisely 1 quaternised nitrogen atom is present.

Also preferred as L′ of formulae (2) and (2′) are compounds in which 2 or 3 quaternised nitrogen atoms are present.

Especially preferred as L′ of formulae (2) and (2′) are compounds in which none of the quaternised nitrogen atoms is bonded directly to one of the pyridine rings A, B or C.

Metal complex compounds of formula (1) are known or can be obtained analogously to known processes. They are obtained in a manner known per se by reacting at least one ligand L of formula (2) in the desired molar ratio with a metal compound, especially a metal salt, such as the chloride, to form the corresponding metal complex. The reaction is carried out, for example, in a solvent, such as water or a lower alcohol, such as ethanol, at a temperature of, for example, from 10 to 60° C., especially at room temperature.

The metal complex compounds of formula (1′) comprising the ligands L′ can be prepared according to methods known per se. Such methods are described in K. T. Potts, D. Konwar, J. Org. Chem. 2000, 56, 4815-4816, E. C. Constable, M. D. Ward, J. Chem. Soc. Dalton Trans. 1990, 1405-1409, E. C. Constable, A. M. W. Cargill Thompson, New. J. Chem. 1992, 16, 855-867, G. Lowe et al, J. Med. Chem., 1999, 42, 999-1006, E. C. Constable, P. Harveson, D. R. Smith, L Whall, Polyhedron 1997, 16, 3615-3623, R. J. Sundberg, S. Jiang, Org. Prep. Proced. Int 1997, 29,117-122, T. Sammakia, T. B. Hurley, J. Org. Chem. 2000, 65, 974-978 and J. Umburg et al., Science 1999, 283, 1524-1527.

Ligands of formulae (2), (2′), (3) and (3′) that are substituted by hydroxy can also be represented as compounds having a pyridone structure in accordance with the following scheme (illustrated here using the example of a terpyridine substituted by hydroxy in the 4′-position):

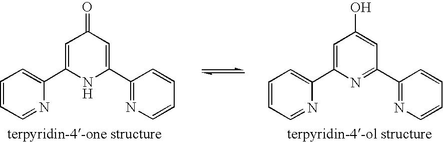

The special position of the above-mentioned hydroxy-substituted terpyridine compounds within the terpyridine family is due to the fact that those ligands can be deprotonated and are therefore able to function as anionic ligands.

Generally, therefore, hydroxy-substituted terpyridines are also to be understood as including those having a corresponding pyridone structure.

Ligands of formulae (2), (2′), (3) and (3′) are known or can be prepared in a manner known per se. For that purpose, for example, two parts pyridine-2-carboxylate and one part acetone can be reacted with sodium hydride, and the intermediate obtained after aqueous working-up, a 1,3,5triketone, can be reacted with ammonium acetate to construct the middle pyridine ring, thereby obtaining the corresponding pyridone derivatives, which can be converted into the chlorine compounds by reaction with a chlorinating agent, such as PCl₅/POCl₃. Reaction of those compounds with amines, as desired in the presence of an excess of redox-active salts of transition metals, such as iron or ruthenium, in order to accelerate substitution, yields amine-substituted terpridines. Such preparation procedures are described, for example, in J. Chem. Soc., Dalton Trans. 1990, 1405-1409 (E. C. Constable et al.,) and New. J. Chem. 1992, 16, 855-867.

It has now been found that, in order to accelerate replacement of halide by amine on the terpyridine structure, it is also possible to use catalytic amounts of non-transition metal salts, such as, for example, zinc(II) salts, which substantially simplifies the reaction procedure and working-up.

Preferably, the metal complex compounds of formula (1) and/or (1′) are used together with molecular oxygen and/or with air in media that are free of hydrogen peroxide or precursors thereof. Examples that may be mentioned in that regard include the following uses:
a) the bleaching of stains or of soiling on textile material in the context of a washing process or by the direct application of a stain remover;
b) the prevention of redeposition of migrating dyes during the washing of textile material;
c) the cleaning of hard surfaces, especially kitchen surfaces, wall tiles or floor tiles, for example to remove stains that have formed as a result of the action of moulds (“mould stains”);
d) use in washing and cleaning solutions having an antibacterial action;
e) as pretreatment agents for bleaching textiles;
f) as catalysts in selective oxidation reactions in the context of organic synthesis,
g) waste water treatment,
h) sterilisation and
i) contact lens disinfection.

A further use is concerned with the use of the metal complex compounds of formula (1) and/or (1′) as catalysts for reactions using molecular oxygen and/or air for bleaching in the context of paper-making. This relates especially to the delignification of cellulose and bleaching of the pulp, which can be carried out in accordance with customary procedures.

Also of interest is the use of the metal complex compounds of formula (1) and/or (1′) as catalysts for reactions using molecular oxygen or air for the bleaching of waste printed paper.

Preference is given to the use of the metal complex compounds of formula (1) and/or (1′) as catalysts for reactions using molecular oxygen and/or air for the bleaching of stains or of soiling on textile material, the prevention of redeposition of migrating dyes in the context of a washing process, or the cleaning of hard surfaces, especially kitchen surfaces, wall tiles or floor tiles. The preferred metals are in this case manganese and/or iron.

It should be emphasised that the use of metal complex compounds, for example, in the bleaching of textile material, does not cause any appreciable damage to fibres and dyeings.

Processes for bleaching stains in a washing liquor are usually carried out by adding to the washing liquor (which comprises a peroxide-free detergent) one or more metal complex compounds of formula (1) and/or (1′). Alternatively, it is possible to add a detergent that already comprises one or two metal complex compounds. It will be understood that in such an application, as well as in the other applications, the metal complex compounds of formula (1) and/or (1′) can alternatively be formed in situ, the metal salt (e.g. manganese(II) salt, such as manganese(II) chloride, and/or iron(II) salt, such as iron(II) chloride) and the ligand being added in the desired molar ratios.

The present invention relates also to a detergent, cleaning, disinfecting or bleaching composition containing
I) from 0 to 50% by weight, preferably from 0 to 30% by weight, A) of at least one anionic surfactant and/or B) of a non-ionic surfactant,
II) from 0 to 70% by weight, preferably from 0 to 50% by weight, C) of at least one builder substance,
III) D) at least one metal complex compound of formula (1) and/or (1′) in an amount that, in the liquor, gives a concentration of from 0.5 to 100 mg/litre of liquor, preferably from 1 to 50 mg/litre of liquor, when from 0.5 to 20 g/litre of the detergent, cleaning, disinfecting or bleaching agent are added to the liquor, and
IV) water ad 100% by weight.

The above percentages are in each case percentages by weight, based on the total weight of the composition. The compositions preferably contain from 0.005 to 2% by weight of at least one metal complex compound of formula (1) and/or (1′), especially from 0.01 to 1% by weight and preferably from 0.05 to 1% by weight.

When the compositions according to the invention comprise a component A) and/or B), the amount thereof is preferably from 1 to 50%, especially from 1 to 30%, by weight.

When the compositions according to the invention comprise a component C), the amount thereof is preferably from 1 to 70% by weight, especially from 1 to 50% by weight. Special preference is given to an amount of from 5 to 50% by weight and especially an amount of from 10 to 50% by weight.

Corresponding washing, cleaning, disinfecting or bleaching processes are usually carried out by using an aqueous liquor containing from 0.1 to 200 mg of one or more compounds of formula (1) and/or (1′) per litre of liquor. The liquor preferably contains from 1 to 50 mg of at least one compound of formula (1) and/or (1′) per litre of liquor. In order to increase activity, for example air and/or molecular oxygen can be blown through the liquor.

The composition according to the invention can be, for example, a peroxide-free heavy-duty detergent or a separate bleaching additive, or a stain remover that is to be applied directly. A bleaching additive is used for removing coloured stains on textiles in a separate liquor before the clothes are washed with a bleach-free detergent. A bleaching additive can also be used in a liquor together with a bleach-free detergent

Stain removers can be applied directly to the textile in question and are used especially for pretreatment in the event of heavy local soiling. The stain remover can be applied in liquid form, by a spraying method or in the form of a solid substance.

Granules can be prepared, for example, by first preparing an initial powder by spray-drying an aqueous suspension comprising all the components listed above except for component D), and then adding the dry component D) and mixing everything together. It is also possible to add component D) to an aqueous suspension containing components A), B) and C) and then to carry out spray-drying.

It is also possible to start with an aqueous suspension that comprises components A) and C), but none or only some of component B). The suspension is spray-dried, and then component D) is mixed with component B) and added.

It is also possible to mix all the components together in the dry state.

The anionic surfactant A) can be, for example, a sulfate, sulfonate or carboxylate surfactant or a mixture thereof. Preference is given to alkylbenzenesulfonates, alkyl sulfates, alkyl ether sulfates, olefin sulfonates, fatty acid salts, alkyl and alkenyl ether carboxylates or to an α-sulfonic fatty acid salt or an ester thereof.

Preferred sulfonates are, for example, alkylbenzenesulfonates having from 10 to 20 carbon atoms in the alkyl radical, alkyl sulfates having from 8 to 18 carbon atoms in the alkyl radical, alkyl ether sulfates having from 8 to 18 carbon atoms in the alkyl radical, and fatty acid salts derived from palm oil or tallow and having from 8 to 18 carbon atoms in the alkyl moiety. The average molar number of ethylene oxide units added to the alkyl ether sulfates is from 1 to 20, preferably from 1 to 10. The cation in the anionic surfactants is preferably an alkaline metal cation, especially sodium or potassium, more especially sodium. Preferred carboxylates are alkali metal sarcosinates of formula R₁₉—CON(R₂₀)CH₂COOM₁ wherein R₁₉ is C₉-C₁₇alkyl or C₉-C₁₇alkenyl, R₂₀ is C₁-C₄alkyl and M₁ is an alkali metal, especially sodium.

The non-ionic surfactant may be, for example, a primary or secondary alcohol ethoxylate, especially a C₈-C₂₀ aliphatic alcohol ethoxylated with an average of from 1 to 20 mol of ethylene oxide per alcohol group. Preference is given to primary and secondary C₁₀-C₁₅ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

The total amount of anionic and non-ionic surfactants is preferably from 5 to 50% by weight, especially from 5 to 40% by weight and more especially from 5 to 30% by weight. The lower limit of those surfactants to which even greater preference is given is 10% by weight.

As builder substance C) there come into consideration, for example, alkali metal phosphates, especially tripolyphosphates, carbonates and hydrogen carbonates, especially their sodium salts, silicates, aluminum silicates, polycarboxylates, polycarboxylic acids, organic phosphonates, aminoalkylenepoly(alkylenephosphonates) and mixtures of such compounds. Silicates that are especially suitable are sodium salts of crystalline layered silicates of the formula NaHSiₜO₂ₜ₊₁.pH₂O or Na₂SiₜO₂ₜ₊₁.pH₂O wherein t is a number from 1.9 to 4 and p is a number from 0 to 20.

Among the aluminum silicates, preference is given to those commercially available under the names zeolite A, B, X and HS, and also to mixtures comprising two or more such components. Special preference is given to zeolite A.

Among the polycarboxylates, preference is given to polyhydroxycarboxylates, especially citrates, and acrylates, and also to copolymers thereof with maleic anhydride. Preferred polycarboxylic acids are nitrilotriacetic acid, ethylenediaminetetraacetic acid and ethylene-diamine disuccinate either in racemic form or in the enantiomerically pure (S,S) form.

Phosphonates or aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid and diethylenetriaminepenta-methylenephosphonic acid, and also salts thereof.

The compositions may comprise, in addition to the combination according to the invention, one or more optical brighteners, for example from the classes bis-triazinylamino-stilbenedisulfonic acid, bis-triazolyl-stilbenedisulfonic acid, bis-styryl-biphenyl or bis-benzofuranylbiphenyl, a bis-benzoxalyl derivative, bis-benzimidazolyl derivative or coumarin derivative or a pyrazoline derivative.

The compositions may furthermore comprise one or more auxiliaries. Such auxiliaries are, for example, dirt-suspending agents, for example sodium carboxymethylcellulose; pH regulators, for example alkali metal or alkaline earth metal silicates; foam regulators, for example soap; salts for adjusting the spray drying and the granulating properties, for example sodium sulfate; perfumes; and also, if appropriate, antistatics and softening agents such as, for example, smectite; bleaching agents; pigments; and/or toning agents. These constituents should especially be stable to any bleaching agent employed.

Such auxiliaries are added in a total amount of from 0.1 to 20% by weight, preferably from 0.5 to 10% by weight, especially from 0.5 to 5% by weight, based on the total weight of the detergent formulation.

Furthermore, the detergent may optionally also comprise enzymes. Enzymes can be added for the purpose of stain removal. The enzymes usually improve the action on stains caused by protein or starch, such as, for example, blood, milk, grass or fruit juices. Preferred enzymes are cellulases and proteases, especially proteases. Cellulases are enzymes that react with cellulose and its derivatives and hydrolyse them to form glucose, cellobiose and cellooligosaccharides. Cellulases remove dirt and, in addition, have the effect of enhancing the soft handle of the fabric.

Examples of customary enzymes include, but are by no means limited to, the following:
proteases as described in US-B6 242 405, column 14, lines 21 to 32;
lipases as described in US-B6 242 405, column 14, lines 33 to 46;
amylases as described in US-B6 242 405, column 14, lines 47 to 56; and
cellulases as described in US-B6 242 405, column 14, lines 57 to 64.

The enzymes, when used, may be present in a total amount of from 0.01 to 5% by weight, especially from 0.05 to 5% by weight and more especially from 0.1 to 4% by weight, based on the total weight of the detergent formulation.

In order to enhance the bleaching action, the compositions may, in addition to comprising the catalysts described herein, also comprise photocatalysts the action of which is based on the generation of singlet oxygen.

Further preferred additives to the compositions according to the invention are dye-fixing agents and/or polymers which, during the washing of textiles, prevent staining caused by dyes in the washing liquor that have been released from the textiles under the washing conditions. Such polymers are preferably polyvinylpyrrolidones, polyvinylimidazoles or polyvinylpyridine-N-oxides, which may have been modified by the incorporation of anionic or cationic substituents, especially those having a molecular weight in the range of from 5000 to 60 000, more especially from 10 000 to 50 000. Such polymers are usually used in a total amount of from 0.01 to 5% by weight, especially from 0.05 to 5% by weight, more especially from 0.1 to 2% by weight, based on the total weight of the detergent formulation. Preferred polymers are those mentioned in WO-A-02102865 (see especially page 1, last paragraph and page 2, first paragraph).

The detergent formulations can take a variety of physical forms such as, for example, powder granules, tablets (tabs) and liquid. Examples thereof include, inter alia, conventional high-performance detergent powders, supercompact high-performance detergent powders and tabs. One important physical form is the so-called concentrated granular form, which is added to a washing machine.

Also of importance are so-called compact or supercompact detergents. In the field of detergent manufacture, there is a trend towards the production of such detergents that contain an increased amount of active substances. In order to minimize energy consumption during the washing procedure, compact or supercompact detergents need to act effectively at low washing temperatures, for example below 40° C., or even at room temperature (25° C.). Such detergents usually contain only small amounts of fillers or of substances, such as sodium sulfate or sodium chloride, required for detergent manufacture. The total amount of such substances is usually from 0 to 10% by weight, especially from 0 to 5% by weight, more especially from 0 to 1% by weight, based on the total weight of the detergent formulation. Such (super) compact detergents usually have a bulk density of from 650 to 1000 gA, especially from 700 to 1000 g/l and more especially from 750 to 1000 g/l.

The detergent formulations can also be in the form of tablets (tabs). The advantages of tabs reside in the ease of dispensing and convenience in handling. Tabs are the most compact form of solid detergent formulation and usually have a volumetric density of, for example, from 0.9 to 1.3 kgaitre. To achieve rapid dissolution, such tabs generally contain special dissolution aids:
carbonate/hydrogen carbonate/citric acid as effervescents;
disintegrators, such as cellulose, carboxymethyl cellulose or cross-linked poly(N-vinyl-pyrrolidone);
rapidly dissolving materials, such as sodium (potassium) acetates, or sodium (potassium) citrates;
rapidly dissolving, water-soluble, rigid coating agents, such as dicarboxylic acids.

The tabs may also comprise combinations of such dissolution aids.

The detergent formulation may also be in the form of an aqueous liquid containing from 5 to 50% by weight, preferably from 10 to 35% by weight, of water or in the form of a non-aqueous liquid containing no more than 5% by weight, preferably from 0 to 1% by weight, of water. Non-aqueous liquid detergent formulations may comprise other solvents as carriers. Low molecular weight primary or secondary alcohols, for example methanol, ethanol, propanol and isopropanol, are suitable for that purpose. The solubilising surfactant used is preferably a monohydroxy alcohol but polyols, such as those containing from 2 to 6 carbon atoms and from 2 to 6 hydroxy groups (e.g., 1,3-propanediol, ethylene glycol, glycerol and 1,2-propanediol) can also be used. Such carriers are usually used in a total amount of from 5% to 90% by weight, preferably from 10% to 50% by weight, based on the total weight of the detergent formulation. The detergent formulations can also used in so-called “unit liquid dose” form.

The invention relates also to granules that comprise the catalysts according to the invention and are suitable for incorporation into a powder-form or granular detergent, deaning or bleaching composition. Such granules preferably comprise:
a) from 1 to 99% by weight, preferably from 1 to 40% by weight, especially from 1 to 30% by weight, of at least one metal complex compound of formula (1) and/or (1′),
b) from 1 to 99% by weight, preferably from 10 to 99% by weight, especially from 20 to 80% by weight, of at least one binder,
c) from 0 to 20% by weight, especially from 1 to 20% by weight, of at least one encapsulating material,
d) from 0 to 20% by weight of at least one further additive and
e) from 0 to 20% by weight water.

As binder (b) there come into consideration water-soluble, dispersible or water-emulsifiable anionic dispersants, non-ionic dispersants, polymers and waxes.

The anionic dispersants used are, for example, commercially available water-soluble anionic dispersants for dyes, pigments etc.

The following products, especially, come into consideration: condensation products of aromatic sulfonic acids and formaldehyde, condensation products of aromatic sulfonic acids with unsubstituted or chlorinated diphenyls or diphenyl oxides and optionally formaldehyde, (mono-/di-)allkylnaphthalenesulfonates, sodium salts of polymerised organic sulfonic acids, sodium salts of polymerised alkylnaphthalenesulfonic acids, sodium salts of polymerised alkylbenzenesulfonic acids, alkylarylsulfonates, sodium salts of alkyl polyglycol ether sulfates, polyalkylated polynuclear arylsulfonates, methylene-linked condensation products of arylsulfonic acids and hydroxyarylsulfonic acids, sodium salts of dialkylsufosuccinic acid, sodium salts of alkyl diglycol ether sulfates, sodium salts of polynaphthalenemethane-sulfonates, lignosulfonates or oxylignosulfonates and heterocyclic polysulfonic acids.

Especially suitable anionic dispersants are condensation products of naphthalenesulfonic acids with formaldehyde, sodium salts of polymerised organic sulfonic acids, (mono-/di-)-alkylnaphthalenesulfonates, polyalkylated polynuclear arylsulfonates, sodium salts of polymerised alkylbenzenesulfonic acid, lignosulfonates, oxylignosulfonates and condensation products of naphthalenesulfonic acid with a polychloromethyldiphenyl.

Suitable non-ionic dispersants are especially compounds having a melting point of, preferably, at least 35° C. that are emulsifiable, dispersible or soluble in water, for example the following compounds:
1. fatty alcohols having from 8 to 22 carbon atoms, especially cetyl alcohol;
2. addition products of, preferably, from 2 to 80 mol of alkylene oxide, especially ethylene oxide, wherein some of the ethylene oxide units may have been replaced by substituted epoxides, such as styrene oxide and/or propylene oxide, with higher unsaturated or saturated monoalcohols, fatty acids, fatty amines or fatty amides having from 8 to 22 carbon atoms or with benzyl alcohols, phenyl phenols, benzyl phenols or alkyl phenols, the alkyl radicals of which have at least 4 carbon atoms;
3. alkylene oxide, especially propylene oxide, condensation products (block polymers);
4. ethylene oxide/propylene oxide adducts with diamines, especially ethylenediamine;
5. reaction products of a fatty acid having from 8 to 22 carbon atoms and a primary or secondary amine having at least one hydroxy-lower alkyl or lower alkoxy-lower alkyl group, or alkylene oxide addition products of such hydroxyalkyl-group-containing reaction products;
6. sorbitan esters, preferably having long-chain ester groups, or ethoxylated sorbitan esters, such as polyoxyethylene sorbitan monolaurate having from 4 to 10 ethylene oxide units or polyoxyethylene sorbitan trioleate having from 4 to 20 ethylene oxide units;
7. addition products of propylene oxide with a tri- to hexa-hydric aliphatic alcohol having from 3 to 6 carbon atoms, e.g. glycerol or pentaerythritol; and
8. fatty alcohol polyglycol mixed ethers, especially addition products of from 3 to 30 mol of ethylene oxide and from 3 to 30 mol of propylene oxide with aliphatic monoalcohols having from 8 to 22 carbon atoms.

Especially suitable non-ionic dispersants are surfactants of formula
R₂₃—O-(alkylene-O)ₙ—R₂₄ (7),
wherein
R₂₃ is C₈-C₂₂alkyl or C₈-C₁₈alkenyl;
R₂₄ is hydrogen; C₁-C₄alkyl; a cycloaliphatic radical having at least 6 carbon atoms; or benzyl;
“alkylene” is an alkylene radical having from 2 to 4 carbon atoms and
n is a number from 1 to 60.

The substituents R₂₃ and R₂₄ in formula (7) are advantageously each the hydrocarbon radical of an unsaturated or, preferably, saturated aliphatic monoalcohol having from 8 to 22 carbon atoms. The hydrocarbon radical may be straight-chain or branched. R₂₃ and R₂₄ are preferably each independently of the other an alkyl radical having from 9 to 14 carbon atoms.

Aliphatic saturated monoalcohols that come into consideration include natural alcohols, e.g. lauryl alcohol, myristyl alcohol, cetyl alcohol or stearyl alcohol, and also synthetic alcohols, e.g. 2-ethylhexanol, 1,1,3,3-tetramethylbutanol, octan-2-ol, isononyl alcohol, trimethyl-hexanol, trimethylnonyl alcohol, decanol, C₉-C₁₁oxo-alcohol, tridecyl alcohol, isotridecyl alcohol and linear primary alcohols (Alfols) having from 8 to 22 carbon atoms. Some examples of such Alfols are Alfol (8-10), Alfol (9-11), Alfol (10-14), Alfol (12-13) and Alfol (16-18). (“Alfol” is a registered trade mark of the company Sasol Umited). Unsaturated aliphatic monoalcohols are, for example, dodecenyl alcohol, hexadecenyl alcohol and oleyl alcohol.

The alcohol radicals may be present singly or in the form of mixtures of two or more components, e.g. mixtures of alkyl and/or alkenyl groups that are derived from soybean fatty acids, palm kernel fatty acids or tallow oils.

(Alkylene-O) chains are preferably bivalent radicals of the formulae

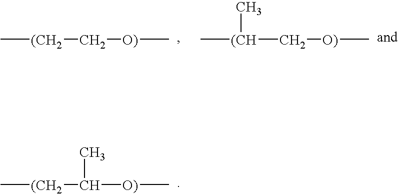

Examples of a cycloaliphatic radical include cycloheptyl, cyclooctyl and preferably cyclohexyl.

As non-ionic dispersants there come into consideration preferably surfactants of formula 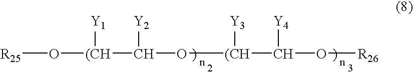
wherein
R₂₅ is C₈-C₂₂alkyl;
R₂₆ is hydrogen or C₁-C₄alkyl;
Y₁, Y₂, Y₃ and Y₄ are each independently of the others hydrogen, methyl or ethyl;
n₂ is a number from 0 to 8; and
n₃ is a number from 2 to 40.

Further important non-ionic dispersants correspond to formula 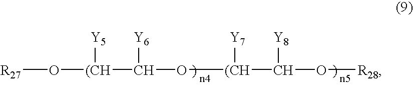
wherein
R₂₇ is C₉-C₁₄alkyl;
R₂₈ is C₁-C₄alkyl;
Y₅, Y₆, Y₇ and Y₈ are each independently of the others hydrogen, methyl or ethyl, one of the radicals Y₅, Y₆ and one of the radicals Y₇, Y₈ always being hydrogen; and
n₄ and n₅ are each independently of the other an integer from 4 to 8.

The non-ionic dispersants of formulae (7) to (9) can be used in the form of mixtures. For example, as surfactant mixtures there come into consideration non-end-group-terminated fatty alcohol ethoxylates of formula (7), e.g. compounds of formula (7) wherein
R₂₃ is C₈-C₂₂alkyl,
R₂₄ is hydrogen and
the alkylene-O chain is the radical —(CH₂—CH₂-O)— and
also end-group-terminated fatty alcohol ethoxylates of formula (9).

Examples of non-ionic dispersants of formulae (7), (8) and (9) include reaction products of a C₁₀-C₁₃fatty alcohol, e.g. a C₁₃oxo-alcohol, with from 3 to 10 mol of ethylene oxide, propylene oxide and/or butylene oxide and the reaction product of one mol of a C₁₃fatty alcohol with 6 mol of ethylene oxide and 1 mol of butylene oxide, it being possible for the addition products each to be end-group-terminated with C₁-C₄alkyl, preferably methyl or butyl.

Such dispersants can be used singly or in the form of mixtures of two or more dispersants.

Instead of, or in addition to, the anionic or non-ionic dispersant, the granules according to the invention may comprise a water-soluble organic polymer as binder. Such polymers may be used singly or in the form of mixtures of two or more polymers.

Water-soluble polymers that come into consideration are, for example, polyethylene glycols, copolymers of ethylene oxide with propylene oxide, gelatin, polyacrylates, polymethacrylates, polyvinylpyrrolidones, vinylpyrrolidones, vinyl acetates, polyvinylimidazoles, polyvinyl-pyridine-N-oxides, copolymers of vinylpyrrolidone with long-chain α-olefins, copolymers of vinylpyrrolidone with vinylimidazole, poly(vinylpyrrolidone/dimethylaminoethyl methacrylates), copolymers of vinylpyrrolidone/dimethylaminopropyl methacrylamides, copolymers of vinylpyrrolidoneldimethylaminopropyl acrylamides, quaternised copolymers of vinyl-pyrrolidones and dimethylaminoethyl methacrylates, terpolymers of vinylcaprolactam/vinylpyrrolidone/dimethylaminoethyl methacrylates, copolymers of vinylpyrrolidone and methacrylamidopropyl-trimethylammonium chloride, terpolymers of caprolactamminyl-pyrrolidone/dimethylaminoethyl methacrylates, copolymers of styrene and acrylic acid, polycarboxylic acids, polyacrylamides, carboxymethyl cellulose, hydroxymethyl cellulose, polyvinyl alcohols, polyvinyl acetate, hydrolysed polyvinyl acetate, copolymers of ethyl acrylate with methacrylate and methacrylic acid, copolymers of maleic acid with unsaturated hydrocarbons, and also mixed polymerisation products of the mentioned polymers. Of those organic polymers, special preference is given to polyethylene glycols, carboxy-methyl cellulose, polyacrylamides, polyvinyl alcohols, polyvinylpyrrolidones, gelatin, hydrolysed polyvinyl acetates, copolymers of vinylpyrrolidone and vinyl acetate, and also polyacrylates, copolymers of ethyl acrylate with methacrylate and methacrylic acid, and polymethacrylates.

Suitable water-emulsifiable or water-dispersible binders also include paraffin waxes.

Encapsulating materials (c) include especially water-soluble and water-dispersible polymers and waxes. Of those materials, preference is given to polyethylene glycols, polyamides, polyacrylamides, polyvinyl alcohols, polyvinylpyrrolidones, gelatin, hydrolysed polyvinyl acetates, copolymers of vinylpyrrolidone and vinyl acetate, and also polyacrylates, paraffins, fatty acids, copolymers of ethyl acrylate with methacrylate and methacrylic acid, and poly-methacrylates.

Further additives (d) that come into consideration are, for example, wetting agents, dust removers, water-insoluble or water-soluble dyes or pigments, and also dissolution accelerators, optical brighteners and sequestering agents.

The preparation of the granules according to the invention is carried out, for example, starting from:
a) a solution or suspension with a subsequent drying/shaping step or
b) a suspension of the active ingredient in a melt with subsequent shaping and solidification.
a) First of all the anionic or non-ionic dispersant and/or the polymer and, optionally, the further additives are dissolved in water and stirred, if desired with heating, until a homogeneous solution is obtained. The catalyst according to the invention is then dissolved or suspended in the resulting aqueous solution. The solids content of the solution should preferably be at least 30% by weight, especially from 40 to 50% by weight, based on the total weight of the solution. The viscosity of the solution is preferably less than 200 mPas.

The aqueous solution so prepared, comprising the catalyst according to the invention, is then subjected to a drying step in which all water, with the exception of a residual amount, is removed, solid particles (granules) being formed at the same time. Known methods are suitable for producing the granules from the aqueous solution. In principle, both continuous methods and discontinuous methods are suitable. Continuous methods are preferred, especially spray-drying and fluidised bed granulation processes.

Especially suitable are spray-drying processes in which the active ingredient solution is sprayed into a chamber with circulating hot air. The atomisation of the solution is effected e.g. using unitary or binary nozzles or is brought about by the spinning effect of a rapidly rotating disc. In order to increase the particle size, the spray-drying process may be combined with an additional agglomeration of the liquid particles with solid nuclei in a fluidised bed that forms an integral part of the chamber (so-called fluid spray). The fine particles (<100 μm) obtained by a conventional spray-drying process may, if necessary after being separated from the exhaust gas flow, be fed as nuclei, without further treatment, directly into the atomizing cone of the atomiser of the spray-dryer for the purpose of agglomeration with the liquid droplets of the active ingredient.

During the granulation step, the water can rapidly be removed from the solutions comprising the catalyst according to the invention, binder and further additives. It is expressly intended that agglomeration of the droplets forming in the atomising cone, or agglomeration of droplets with solid particles, will take place.

If necessary, the granules formed in the spray-dryer are removed in a continuous process, for example by a sieving operation. The fines and the oversize particles are either recycled directly to the process (without being redissolved) or are dissolved in the liquid active ingredient formulation and subsequently granulated again.

A further preparation method according to a) is a process in which the polymer is mixed with water and then the catalyst is dissolved/suspended in the polymer solution, thus forming an aqueous phase, the catalyst according to the invention being homogeneously distributed in that phase. At the same time or subsequently, the aqueous phase is dispersed in a water-immiscible liquid in the presence of a dispersion stabiliser in order that a stable dispersion is formed. The water is then removed from the dispersion by distillation, forming substantially dry particles. In those particles, the catalyst is homogeneously distributed in the polymer matrix.

The granules according to the invention are resistant to abrasion, low in dust, pourable and readily meterable. They can be added directly to a formulation, such as a detergent formulation, in the desired concentration of the catalyst according to the invention.

Where the coloured appearance of the granules in the detergent is to be suppressed, this can be achieved, for example, by embedding the granules in a droplet of a whitish meltable substance (“water-soluble wax”) or by adding a white pigment (e.g. TiO₂) to the granule formulation or, preferably, by encapsulating the granules in a melt consisting, for example, of a water-soluble wax, as described in EP-A-0 323 407, a white solid being added to the melt in order to reinforce the masking effect of the capsule.
b) The catalyst according to the invention is dried in a separate step prior to the melt-granulation and, if necessary, dry-ground in a mill so that all the solids particles are <50 μm in size. The drying is carried out in an apparatus customary for the purpose, for example in a paddle dryer, vacuum cabinet or freeze-dryer.

The finely particulate catalyst is suspended in the molten carrier material and homogenised. The desired granules are produced from the suspension in a shaping step with simultaneous solidification of the melt. The choice of a suitable melt-granulation process is made in accordance with the desired size of granules. In principle, any process which can be used to produce granules in a particle size of from 0.1 to 4 mm is suitable. Such processes are droplet processes (with solidification on a cooling belt or during free fall in cold air), melt-prilling (cooling medium gas/liquid), and flake formation with a subsequent comminution step, the granulation apparatus being operated continuously or discontinuously.

Where the coloured appearance of the granules prepared from a melt is to be suppressed in the detergent, in addition to the catalyst it is also possible to suspend in the melt white or coloured pigments which, after solidification, impart the desired coloured appearance to the granules (e.g. titanium dioxide).

If desired, the granules can be covered with or encapsulated in an encapsulating material. Methods that come into consideration for such an encapsulation include the customary methods and also encapsulation of the granules by a melt consisting e.g. of a water-soluble wax, as described, for example, in EP-A-0 323 407, coacervation, complex coacervation and surface polymerisation.

Encapsulating materials (c) include e.g. water-soluble, water-dispersible or water-emulsifiable polymers and waxes.

As further additives (d) there come Into consideration, for example, wetting agents, dust removers, water-insoluble or water-soluble dyes or pigments, and also dissolution accelerators, optical brighteners and sequestering agents.

Surprisingly, the metal complex compounds of formula (1) and/or (1′) also exhibit a markedly improved bleach-catalysing action on coloured stains occurring on kitchen surfaces, wall tiles or floor tiles.

The use of at least one metal complex compound of formula (1) and/or (1′) as catalyst(s) in cleaning solutions for hard surfaces, especially for kitchen surfaces, wall tiles or floor tiles, is therefore of special interest.

The metal complex compounds of formula (1) and/or (1′) and the corresponding ligands also have excellent antibacterial action. The use thereof for killing bacteria or for protecting against bacterial attack is therefore likewise of interest

The metal complex compounds of formula (1) and/or (1′) are also outstandingly suitable for selective oxidation in the context of organic synthesis, especially the oxidation of organic molecules, e.g. of olefins to form epoxides. Such selective transformation reactions are required especially in process chemistry. The invention accordingly relates also to the use of the metal complex compounds of formula (1) and/or (1′) in selective oxidation reactions in the context of organic synthesis.

The following Examples serve to illustrate the invention but do not limit the invention thereto. Parts and percentages relate to weight, unless otherwise indicated. Temperatures are in degrees Celsius, unless otherwise indicated.

### EXAMPLES

### SYNTHESIS OF 4′-SUBSTITUTED TERPYRIDINES AND 4-PYRIDONES

### Example 1

### 1′H-[2,2′;6′,2″]Terpyridin-4′-one (hereinafter called L1)

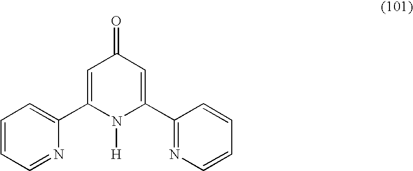 a) Step 1:

Under a nitrogen atmosphere, a solution of 20.2 ml (22.7 g, 150 mmol) of pyridine-2-carboxylic acid ethyl ester and 3.6 ml (50 mmol) of dry acetone in 100 ml of dry tetrahydrofuran is added under reflux to a suspension of 6 g (approximately 60% dispersion in paraffin oil, about 150 mmol) of sodium hydride in 100 ml of dry tetrahydrofuran in the course of 4 hours. Refluxing is continued for a further 2 hours, and then concentration is carried out using a rotary evaporator. After the addition of 200 ml of ice-water, the mixture is rendered neutral using 50% acetic acid and the yellow 1,5-di-pyrid-2-yl-pentane-1,3,5trione obtained is filtered off.

IR (cm⁻¹): 2953 (s); 2923 (vs); 2854 (m); 1605 (m); 1560 (s); 1447 (w); 1433 (w); 1374 (m); 1280 (w); 786 (w).

b) Step 2:

A mixture of 10 g (37 mmol) of 1,5-di-pyrid-2-yl-pentane-1,3,5-trione and 20 g (260 mmol) of ammonium acetate is refluxed for 8 hours in 250 ml of ethanol. The mixture so obtained is concentrated to approximately half its volume. 1′H-[2,2′;6′,2″]Terpyridin-4′-one is obtained in the form of a white solid after filtration.

¹H-NMR (360 MHz, DMSO-d₆): 7.40-7.50 (qm, 2H); 7.87 (s, 2H); 7.92-8.0 (tm, 2H); 8.57 (d, 2H, 7.7 Hz); 8.68 (d, 2H, J=4.5 Hz), 10.9 (s, 1H).

MS (EI pos., 70 eV), m/z=249 (100, [M⁺]); 221 (40).

(for preparation, see also K. T. Potts, D. Konwar, J. Org. Chem. 2000, 56, 4815-4816 and E. C. Constable, M. D. Ward, J. Chem. Soc. Dalton Trans. 1990, 1405-1409).

### Example 2

### 4′-Chloro-[2,2′;6′,2″]terpyridine (hereinafter called L2)

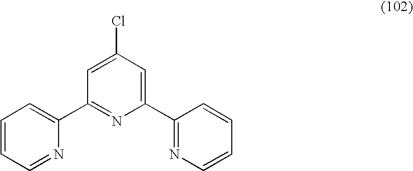

A mixture of 3.99 g (16 mmol) of 1′H-[2,2′;6′,2″]terpyridin-4′-one (L1) and 8.0 g (38 mmol) of phosphorus pentachloride is refluxed for 16 hours in 200 ml of phosphorus oxychloride. The mixture is allowed to cooled and concentrated to dryness. 200 ml of ice-water are then cautiously added to the residue, and the solution is subsequently adjusted to pH 9 using aqueous potassium hydroxide solution. Extraction is carried out three times using chloroform, and the organic extracts are dried over sodium sulfate, filtered and concentrated. 4′-Chloro-[2,2′;6′,2″]terpyridine is obtained in the form of white needles after recrystallisation from ethanol.

¹H-NMR (CDCl₃, 360 MHz): 7.20-7.29 (m, 2H); 7.70-7.79 (tm, 2H); 8.37 (s, 2H); 8.47 (d, 2H; 7.6 Hz); 8.56-8.63 (dm, 2H).

(for preparation, see also E. C. Constable, M. D. Ward, J. Chem. Soc. Dalton Trans. 1990, 1405-1409).

### Example 3

### 4′-Ethoxy-[2,2′;6′,2″]terpyridine (hereinafter called L3)

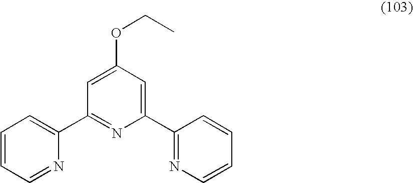

900 mg (3.4 mmol) of 4′-chloro-[2,2′;6′,2″]terpyridine is added under a nitrogen atmosphere to 15 ml of a 0.7 molar ethanolic sodium ethanolate solution. The mixture is heated at reflux for 20 hours and allowed to cool. 20 ml of water are added, and 4′-ethoxy-[2,2′;6′,2″]terpyridine is filtered off in the form of a white solid.

¹H-NMR (360 MHz, DMSO-d₆): 1.40 (t, 3H, 6.8 Hz); 4.28 (q, 2H, 6.8 Hz); 7.42-7.53 (m, 2H); 7.93 (s, 2H); 7.95-8.02 (m, 2H); 8.58 (d, 2H, J=8.1 Hz); 8.69 (d, 2H, J=4 Hz).

(for preparation, see also E. C. Constable, A. M. W. Cargill Thompson, New. J. Chem. 1992, 16, 855-867).

### Example 4

### [2,2′;6′,2″]Terpyrid-4′-yl-hydrazine (hereinafter called L4)

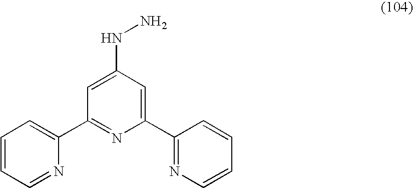

4 ml (126 mmol) of hydrazine are added to 600 mg (2.2 mmol) of 4′-chloro-[2,2′;6′,2″]terpyridine in 12 ml of 2-butanol. The mixture is heated at reflux for 17 hours, cooled, and [2,2′;6′,2″]terpyrid-4′-yl-hydrazine is filtered off in the form of a white solid.

¹H-NMR (360 MHz, DMSO₆): 4.38 (s br, 2H); 7.38-7.45 (m, 2H); 7.84 (s, 2H); 7.88-7.97 (m, 3H); 8.52-8.57 (m, 2H); 8.64-8.76 (m, 2H).

(for preparation, see also G. Lowe et at., J. Med. Chem., 1999, 42, 999-1006).

### Example 5

### 2-(Methyl-[2,2′;6′,2″]terpyrid-4′-yl-amino)-ethanol (hereinafter called L5)

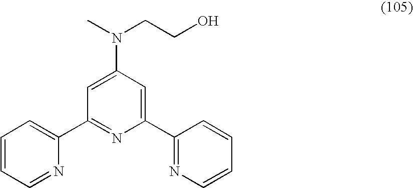

A 20 ml dichloromethane solution of 1.61 g (6 mmol) of 4′-chloro-2,2′;6′,2″-terpyridine and 20 ml of N-methylaminoethanol are added in succession to a solution of 1.35 g (6.8 mmol) of Iron(II) chloride tetrahydrate in 100 ml of isopropanol. Refluxing is then carried out for 20 hours. Concentration is carried out and a solution of 1.66 g of ammonium hexafluoro-phosphate in 10 ml of methanol is added. The resulting violet precipitate is washed four times with 50 ml of diethyl ether each time, and once with 50 ml of water. The residue is then stirred for 14 hours in a solution of 4 g of sodium hydroxide in 300 ml of water/acetonitrile (1:1 v/v) under an oxygen atmosphere. Filtration over diatomaceous earth is carried out and the residue is washed with 50 ml of water, 50 ml of acetonitrile and 100 ml of dichloro-methane. The filtrates are concentrated. Extraction is carried out four times with dichloro-methane; the combined organic extracts are dried over sodium sulfate, filtered and concentrated. The residue is recrystallised from acetone/petroleum ether and acetonitrile. 2-(Methyl-[2,2′;6′,2″]terpyrid-4′-yl-amino)-ethanol is obtained in the form of a white solid.

MS (ESI pos., KF), m/z=345 (100, [M+K]⁺); 307 (35, [M+H]⁺).

(for preparation, see also G. Lowe et al., J. Med. Chem., 1999, 42, 999-1006).

### Example 6

### 4′-Pyrrolidin-1-yl-[2,2′;6′,2″]terpyridine (hereinafter called L6)

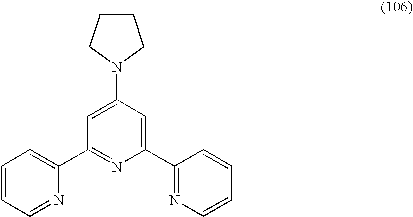

28 mg (<5 mol %) of zinc(II) chloride and 4.4 g (61.5 mmol) of pyrrolidine are added in succession to a mixture of 1.1 g (4.1 mmol) of 4-chloro-[2,2′;6′,2″]terpyridine in 15 ml of 2-methyl-2-butanol. The mixture is heated at reflux for 20 hours, cooled and filtered. Pure 4′-pyrrolidin-1-yl-[2,2′;6′,2″]terpyridine is obtained in the form of a white solid after recrystallisation from toluene.

MS (EI, 70 eV): m/z=303 (15); 302 (90, [M⁺]); 273 (100); 233 (25).

¹H-NMR (360 MHz, CDCl₃): 1.9-2.0 (m, 4H); 3.39-3.49 (m, 4H); 7.18 (dd, 2H, J=6.7, 5.2 Hz); 7.51 (s, 2H); 7.66-7.76 (tm, 2H); 8.51 (d, 2H, J=7.7 Hz); 8.54-8.60 (m, 2H).

### Example 7

### 2-[(2-Hydroxy-ethyl)-[2,2′;6′,2″]terpyrid-4′-yl-amino]-ethanol (hereinafter called L7)

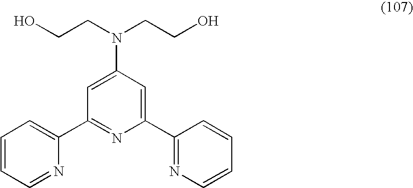

3.41 g (17.2 mmol) of manganese(II) chloride tetrahydrate and 98 g (0.93 mol) of diethanolamine are added in succession to a mixture of 2.14 g (8 mmol) of 4′-chloro-[2,2′;6′,2″]terpyridine in 200 ml of methanol. The mixture is heated at reflux for 14 hours, cooled and concentrated. The residue so obtained is stirred in 250 ml of sodium hydroxide solution in acetonitrile/water 1:1 (v/v, pH>12) for 20 hours in air. Acetonitrile is removed using a rotary evaporator, and the aqueous portion is extracted three times with chloroform. The organic extract is filtered over sodium sulfate and concentrated. Diethyl ether is added to the residue and stirred and filtered to yield 2-[(2-hydroxy-ethyl)-[2,2′;6′,2″]terpyrid-4′-yl-amino]-ethanol in the form of a white solid.

¹H-NMR (360 MHz, CD₃OD): 3.76 (t, J=5.4 Hz, 4H); 3.85 (t, J=5.4 Hz, 4H); 7.38-7.47 (tm, 2H); 7.69 (s, 2H); 7.94 (dt, J=8.1, 1.8 Hz, 2H); 8.53 (d, J=8.1 Hz, 2H); 8.58-8.65 (dm, 2H).

### Example 8

### 4′-(4-Methyl-piperazin-1-yl)-[2,2′;6′,2″]terpyridine (hereinafter called L8)

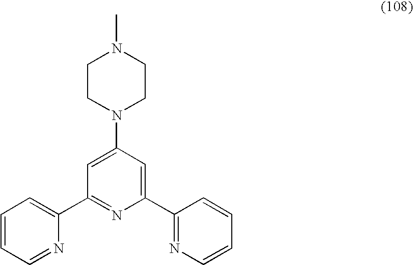

The preparation of this compound is carried out in a manner analogous to that indiciated above for the preparation of the ligand L7 in Example 7, but using 1-methylpiperazine as the amine component. 4-(4-Methyl-piperazin-1-yl)-[2,2′;6′,2″]terpyridine, white solid.

¹³C-NMR (90 MHz, CDCl₃): 157.1 (2 signals, quat.); 156.3 (quat.); 149.1 (tert); 137.0 (tert.); 123.8 (tert.); 121.6 (tert.); 105.7 (tert.); 55.0 (sec.); 46.6 (sec.); 46.4 (prim.).

MS (EI pos., 70 eV), m/z=331 (100, [M⁺]), 261 (95); 233 (40); 70 (40); 50 (43).

### Example 8b

### 1,1-Dimethyl-4-[2,2′;6′,2″]terpyrid-4′-yl-piparazin-1-ium iodide (hereinafter called L8b)

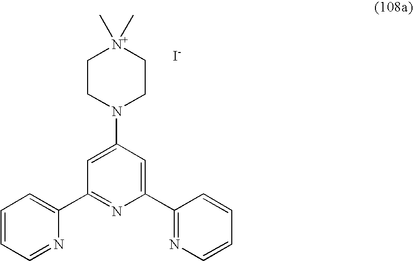

211 mg (0.64 mmol) of ligand L8 are dissolved in 11 ml of acetonitrile and, at room temperature, an excess of methyl iodide (2.1 ml) is added. Stirring at room temperature is carried out for 3 hours, concentration is carried out and 10 ml of dichloromethane are added to the residue. The precipitate is filtered off and dried in vacuo; 1,1-dimethyl-4-[2,2′;6′,2″]terpyrid-4′-yl-piperazin-1-ium iodide, beige solid.

¹H-NMR (360 MHz, CD₃OD): 3.34 (s, 6H), 3.62-3.80 (m, 4H); 3.85-4.03 (m, 4H); 7.39-7.52 (m, 2H); 7.86-8.03 (m, 4H); 8.57 (d, J=7.7 Hz, 2H); 8.63 (d, J=4.5 Hz, 2H).

### Example 9

### 4′-Azepan-1-yl-[2,2′;6′,2″]terpyridine (hereinafter called L9)

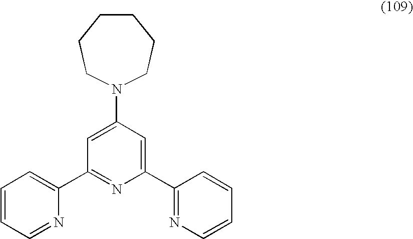

The preparation of this compound is carried out in a manner analogous to that indiciated above for the preparation of the ligand L7 in Example 7, but using hexamethyleneimine as the amine component. 4-Azepan-1-yl-[2,2′;6′,2″]terpyridine, white solid. ¹³C-NMR (90 MHz, CDCl₃): 157.7 (quat.); 156.1 (quat.); 155.6 (quat.); 149.2 (tert.); 137.0 (tert.); 123.7 (tert.); 121.8 (tert.); 103.7 (tert.); 49.4 (sec.); 27.9 (sec.); 27.4 (sec.).

MS (EI pos., 70 eV), m/z=330 (100, [M⁺]); 287 (45); 273 (25); 233 (20).

### Example 10

### 4-Piperidin-1-yl-[2,2′;6′,2″]terpyridine (hereinafter called L10)

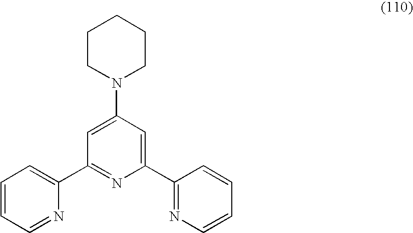

The preparation of this compound is carried out in a manner analogous to that indiciated above for the preparation of the ligand L7 in Example 7, but using piperidine as the amine component. 4′-Piperidin-1-yl-[2,2′;6′,2″]terpyridine, white solid.

¹³C-NMR (CDCl₃): 157.4 (quat.); 157.3 (quat.); 156.2 (quat.); 149.2 (tert.); 137.1 (tert.); 123.8 (tert.); 121.8 (tert.); 105.7 (tert.); 48.1 (sec.); 25.9 (sec.); 24.9 (sec.).

MS (EI pos., 70 eV), m/z=316 (100, [M⁺]); 287 (35); 261 (25); 233 (70).

### Example 11

### 4′-Morpholin-4-yl-[2,2′;6′,2″]terpyridine (hereinafter called L11)

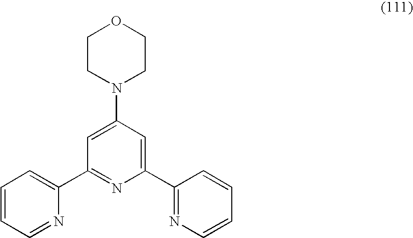

The preparation of this compound is carried out in a manner analogous to that indiciated above for the preparation of the ligand L7 in Example 7, but using morpholine as the amine component. 4-Morpholin-4-yl-[2,2′;6′,2″]terpyridine, white solid.

¹³C-NMR (CDCl₃): 157.6 (quat.); 157.0 (quat.); 156.5 (quat.); 149.2 (tert.); 137.2 (tert.); 124.0 (tert); 121.8 (tert.); 105.7 (tert.); 67.0 (sec.); 47.0 (sec.).

MS (EI pos., 70 eV), m/z=318 (100, [M⁺]); 287 (35); 261 (45); 233 (85).

### Example 12

### 4′-(4-tert-Butyl-phenyl)-[2,2′;6′,2″]terpyridine (hereinafter called L12)

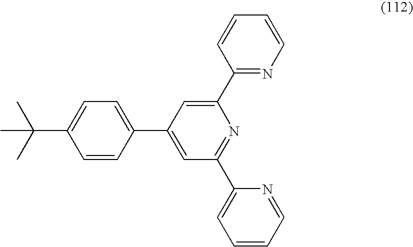

4.06 g (25 mmol) of 4-tert-butyl benzaldehyde are dissolved in 150 ml of ethanol. Sodium hydroxide solution (5.13 g in 40 ml of water) is added, and then 10.54 g (87 mmol) of 2-acetylpyridine are added dropwise in the course of 10 minutes. The mixture is subsequently stirred at room temperature for 18 hours. The pale pink precipitate so obtained is filtered off with suction and washed with 10 ml each of methanol and water. A second fraction is obtained from the mother liquor by adding water. 2.54 g of the residue so obtained are then taken up in 160 ml of glacial acetic acid, 32 g (excess) of ammonium acetate are added, and heating at reflux is carried out for 3 hours. The mixture is cooled, neutralised using sodium carbonate solution and extracted twice with dichloromethane. Drying over sodium sulfate, filtration and concentration of the organic extract are carried out. After recrystallisation from methanol, 4′-(4-tert-butyl-phenyl)-[2,2′;6′,2″]terpyridine is obtained in the form of a white solid.

¹³C-NMR (90 MHz, CDCl₃): 156.8 (quat.); 156.3 (quat); 152.7 (quat.); 150.5 (quat.); 149.5 (tert); 137.2 (tert.); 135.9 (quat.); 127.4 (tert.); 126.3 (tert.); 124.1 (tert.); 121.8 (tert.); 119.2 (tert.); 35.0 (quat); 31.6 (prim.).

(for preparation, see also E. C. Constable, P. Harveson, D. R. Smith, L. Whall, Polyhedron 1997,16,3615-3623).

### Example 13

### 4′-(4-Isopropyl-phenyl)-[2,2′;6′,2″]terpyridine (hereinafter called L13)

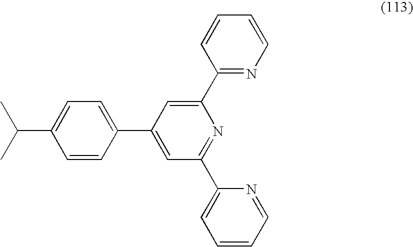

The preparation of this compound is carried out in a manner analogous to that described above for ligand L12 in Example 12, but using 4-isopropylbenzaldehyde as the carbonyl component. 4′-(4-Isopropylphenyl)-[2,2′;6′,2″]terpyridine, white solid.

¹³C-NMR (90 MHz, CDCl₃): 155.4 (quat.); 155.0 (quat.); 149.3 (quat.); 149.1 (quat.); 148.2 (tert.); 135.9 (tert.); 135.0 (quat.); 126.4 (tert.); 125.8 (tert.); 122.8 (tert.); 120.5 (tert.); 117.6 (tert.); 30.0 (tert.); 23.0 (prim.).

### Example 14

### 4′-p-Tolyl-[2,2′;6′,2″]terpyridine (hereinafter called L14)

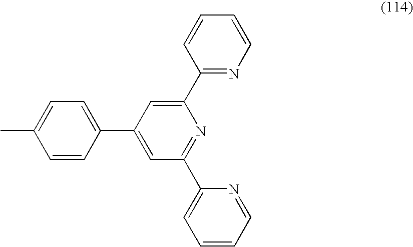

The preparation of this compound is carried out in a manner analogous to that described above for ligand L12 in Example 12, but using 4-methylbenzaldehyde as carbonyl component 4′-p-Tolyl-[2,2′;6′,2]terpyridine, white solid.

¹³C-NMR (90 MHz, CDCl₃): 155.8 (quat.); 155.3 (quat.); 149.6 (quat.); 148.5 (tert.); 138.5 (quat.); 136.0 (tert.); 134.9 (quat.); 128.7 (tert.); 126.6 (tert.); 123.2 (tert.); 120.8 (tert.); 118.0 (tert.); 20.7 (prim.).

### Example 15

### 4′-Biphenyl-4-yl-[2,2′;6′,2″]terpyridine (hereinafter called L15)

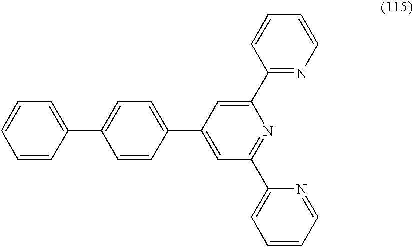

The preparation of this compound is carried out In a manner analogous to that described above for ligand L12 in Example 12, but using 4-phenylbenzaldehyde as carbonyl component. 4′-Biphenyl-4-yl-[2,2′;6′,2″]terpyridine, white solid.

¹³C-NMR (90 MHz, CDCl₃): 156.6 (quat.); 156.3 (quat.); 150.0 (quat.); 149.5 (tert.); 142.2 (quat.); 140.8 (quat.); 137.6 (quat); 136.9 (tert.); 129.3 (tert.); 128.1 (tert.); 128.0 (tert.); 127.9 (tert.); 126.3 (tert.); 124.2 (tert.); 121.8 (tert.); 119.1 (tert.).

Synthesis of Building Blocks for Polysubstituted Ligands of the Pyridone Type

### Example 16

### 4-Chloro-pyridine-2-carboxylic acid methyl ester

a) Step 1:

36.9 g (0.3 mol) of pyridine-2-carboxylic acid are dissolved in 105 ml of thionyl chloride. After the addition of 3.1 g (30 mmol) of sodium bromide, heating to reflux temperature is cautiously carried out and boiling is continued for a further 24 hours, the gases formed being conveyed away through a wash bottle charged with sodium hydroxide solution. When the reaction is complete, cooling and concentration by evaporation using a rotary evaporator are carried out.

b) Step 2:

300 ml of methanol are cautiously added at 0° C., with stirring, to the brown residue obtained in Step 1. The mixture is warmed to room temperature and stirred for a further 30 minutes to complete the reaction. Concentration is carried out, 750 ml of 5% sodium hydrogen carbonate solution are added, and extraction is carried out three times with ethyl acetate. The organic extracts are dried over sodium sulfate, filtered and concentrated. The crude product so obtained is distilled in a sickle flask (approx. 100-120° C., 0.1 mbar). 4-Chloro-pyridine-2-carboxylic acid methyl ester is obtained in the form of a white solid.

¹H-NMR (360 MHz, CDCl₃): 4.01 (s, 3H); 7.44 (dd, 1H, J=5.4, 1.8 Hz); 8.12 (d, 1H, J=1.8 Hz); 8.4 (d, 1H. J=5.4 Hz).

(for preparation, see also R. J. Sundberg, S. Jiang, Org. Prep. Proced. Int. 1997, 29, 117-122).

### Example 17

### 4-Chloro-pyridine-2-carboxylic acid ethyl ester

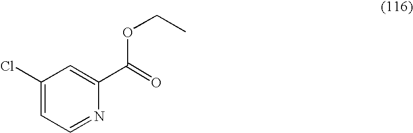 a) Step 1:

10.0 ml (0.130 mol) of N,N-dimethylformamide are added dropwise to 295 ml of (4.06 mol) of thionyl chloride at 40° C. with stirring. 100 g (0.812 mol) of picolinic acid are then added in the course of half an hour. The mixture is cautiously heated to 700C and stirred at that temperature for 24 hours, the gases formed being conveyed away through a wash bottle charged with sodium hydroxide solution. Concentration and co-evaporation a further three times with 100 ml of toluene each time are carried out, the residue is diluted with that solvent to 440 ml, and the solution is introduced into a mixture of 120 ml of absolute ethanol and 120 ml of toluene. The mixture is concentrated to approximately half its volume, cooled to 4° C., filtered with suction and washed with toluene. 4-Chloro-pyridine-2-carboxylic acid ethyl ester hydrochloride is obtained in the form of a beige, hygroscopic powder.

b) Step 2:

The hydrochloride obtained in Step 1 is taken up in 300 ml of ethyl acetate and 200 ml of deionised water and rendered neutral with 4N sodium hydroxide solution. After separation of the phases, extraction is carried out twice using 200 ml of ethyl acetate each time. The organic phases are combined, dried over sodium sulfate, filtered and concentrated. 4-Chloro-pyridine-2-carboxylic acid ethyl ester is obtained in the form of a brown oil which, if required, can be purified by distillation.

¹H-NMR (360 MHz, CDCl₃): 8.56 (d, 1H, J=5.0 Hz); 8.03 (d, 1H, J=1.8 Hz); 7.39 (dd, 1H, J=5.4, 1.8 Hz); 4.39 (q, 2H, J=7.0 Hz); 1.35 (t, 3H, J=7.0 Hz).

### Example 18

### 4-Ethoxy-pyridine-2-carboxylic acid ethyl ester

This compound is obtained in a manner analogous to that described in Example 16, except that, in Step 2, ethanol is used instead of methanol and the mixture is heated at reflux for 24 hours after the addition of the alcohol. The crude product is purified by distillation (100-105° C., 0.08 mbar). 4-Ethoxy-pyridine-2-carboxylic acid ethyl ester is obtained in the form of a colourless oil.

¹H-NMR (360 MHz, CDCl₃): 1.44 (m, 6H); 4.15 (q, 2H, J=7.0 Hz); 4.47 (q, 2H, J=7.0 Hz); 6.94 (dd, 1H, J=5.1, 2.7 Hz); 7.65 (d, 2H, J=2.7 Hz); 8.54 (d, 1H; J=5.7 Hz).

### Example 19

### 4-Pyrrolidin-1-yl-pyridine-2-carboxylic acid ethyl ester

a) Step 1:

This Step is carried out in a manner analogous to that indicated in Step 1 in Example 16.

b) Step 2:

This Step is carried out as described in T. Sammakia, T. B. Hurley, J. Org. Chem. 2000, 65, 974-978: to the resulting crude acid chloride in dichloromethane there is added dropwise, at 0° C., a dichloromethane solution of a threefold excess of pyrrolidine and catalytic amounts of N,N-dimethylaminopyridine. Stirring is carried out for a further hour at room temperature, followed by heating at reflux for 5 hours and concentration using a rotary evaporator. The residue is then extracted five times with diethyl ether. The ethereal extracts are concentrated. The residue is then taken up in 6M hydrochloric acid and refluxed for 6 hours. On concentration using a rotary evaporator, pure 4-pyrrolidin-1-yl-pyridine-2-carboxylic acid is obtained. For the synthesis of 4-pyrrolidin-1-yl-pyridine-2-carboxylic acid ethyl ester, the carboxylic acid is taken up in thionyl chloride and heated at the boil for 30 minutes. Concentration is carried out using a rotary evaporator and the procedure is then as described in Example 16, Step 2, except that the alcohol used is ethanol.

### Example 20

### 1,5-Bis(4-chloropyrid-2-yl)-pentane-1,3,5-trione

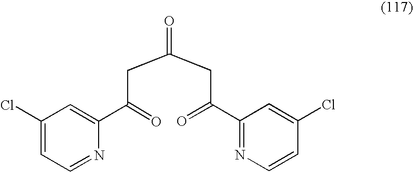

This compound is prepared in a manner analogous to that in Example 1, Step 1, except that, instead of pyridine-2-arboxylic acid ethyl ester, 4-chloro-pyridine-2-carboxylic acid methyl ester from Example 16 is employed. The beige, solid crude product is used, without special purification steps, for further syntheses.

IR (cm⁻): 1619 (m); 1564 (s); 1546 (s); 1440 (m); 1374 (s); 1156 (m); 822 (w).

### Example 21

### 1,5-Bis(4-ethoxy-pyrid-2-yl)-pentane-1,3,5-trione

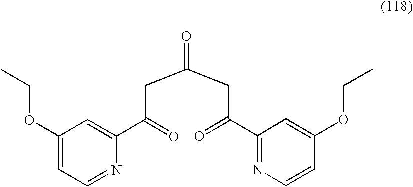

This compound is prepared in a manner analogous to that described in Example 1, Step 1, except that, instead of pyridine-2-carboxylic acid ethyl ester, 4-ethoxy-pyridine-2-carboxylic acid ethyl ester from Example 18 is employed. The yellowish crude product is used, without special purification steps, for further syntheses.

IR (cm⁻): 1557 (vs); 1469 (w); 1436 (w); 1300 (m); 1207 (m); 1186 (m); 1035 (m); 818 (m).

### Example 22

### 1,5-Bis(4-pyrrolidin-1-yl-pyrid-2-yl)-pentane-1,3,5-trione

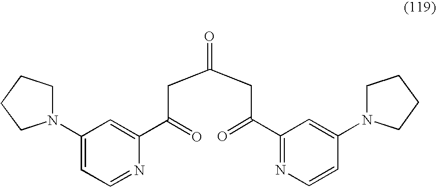

This compound is prepared in a manner analogous to that described in Example 1, Step 1, except that, Instead of pyridine-2-carboxylic acid ethyl ester, 4-pyrrolidin-1-yl-pyridine-2-carboxylic acid ethyl ester from Example 19 is employed. The yellowish-orange crude product is used, without special purification steps, for further syntheses.

IR (cm⁻¹): 1548 (s); 1504 (s); 1453 (s); 1381 (s); 1349 (m); 1276 (w); 1243 (M); 1207 (w); 796 (w).

### Example 23

### 1-Pyrid-2-yl-butane-1,3-dione

Under argon, a solution of 8.71 g (150 mmol) of dry acetone in 100 ml of absolute tetrahydrofuran is added to a solution of 20.42 g (300 mmol) of sodium ethanolate in 300 ml of absolute tetrahydrofuran. A solution of 22.68 g (150 mmol) of pyridine-2-arboxylic acid ethyl ester in 100 ml of absolute tetrahydrofuran is then added dropwise in the course of 20 minutes. The mixture is stirred for 15 hours at room temperature and for four hours at boiling temperature. Concentration is carried out using a rotary evaporator, 150 ml of water are added, and the mixture is rendered neutral by glacial acetic acid. Extraction is carried out twice with diethyl ether, and the organic extracts are combined and dried (sodium sulfate), yielding 1-pyrid-2-yl-butane-1,3-dione in the form of an orange oil after concentration using a rotary evaporator.

¹H-NMR (360 MHz, CDCl₃) for enol tautomer 15.8-15.5 (br s, OH); 8.60-8.55 (dm, 1H); 8.20-7.95 (dm, 1H); 7.79-7.71 (tm, 1H); 7.35-7.29 (m, 1H); 6.74 (s, 1H); 2.15 (s, 3H). Keto tautomer CH₂— group at 4.20 ppm (enol/keto form ratio=87:13).

### Example 24

### 1-(4Chloro-pyrid-2-yl)-5-pyrid-2-yl-pentane-1,3,5-trione

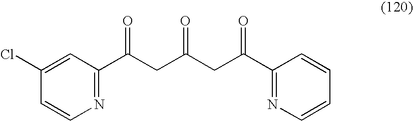

At boiling temperature, a mixture of 21.3 g (131 mmol) of 1-pyrid-2-yl-butane-1,3-dione and 36.3 g (196 mmol) of 4-chloro-pyridine-2-carboxylic acid ethyl ester in 100 ml of absolute tetrahydrofuran is added dropwise in the course of two hours to 10.43 g (261 mmol, approx. 60% dispersion) of sodium hydride in 200 ml of absolute tetrahydrofuran. The mixture is then stirred for a further 2 hours at 70° C. and concentrated using a rotary evaporator and then, at 4° C., 200 ml of water are cautiously added. The mixture is rendered neutral with 5N hydrochloric acid, and 1-(4-chloro-pyrid-2-yl)-5-pyrid-2-yl-pentane-1,3,5-trione is filtered off in the form of a yellowish-green solid. The dried, sparingly soluble product is further processed without special purification steps.

Synthesis of Polysubstituted Terpyridines and Pyridones

### Example 25

### 4,4″-Dichloro-1′H-[2,2′;6′,2″]terpyridin-4′-one (hereinafter called L16)

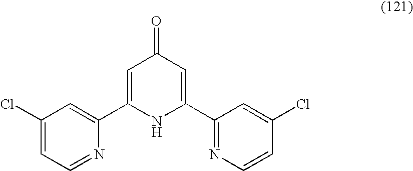

This compound is prepared in a manner analogous to that described in Example 1, Step 2, except that, instead of 1,5-di-pyrid-2-yl-pentane-1,3,5-trione, the chloro-substituted triketone from Example 20 is employed. Pure 4,4″-dichloro-1′H-[2,2′;6′,2″]terpyridin-4′-one can be obtained in the form of a white crystalline powder by recrystallisation from toluene.

¹³C-NMR (90 MHz, CDCl₃): 165.6 (quat.); 156.5 (quat.); 154.9 (quat.); 150.2 (tert.); 143.6 (quat.); 123.7 (tert.); 120.2 (tert.); 108.5 (tert.).

### Example 26

### 4,4″-Diethoxy-1′H-[2,2′;6′,2″]terpyridin-4′-one (hereinafter called L17)

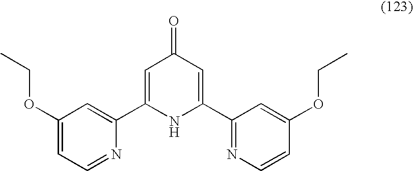

This compound is prepared in a manner analogous to that described in Example 1, Step 2, for 1,5-di-pyrid-2-yl-pentane-1,3,5-trione but, instead, the ethoxy-substituted triketone from Example 21 is employed. Pure 4,4″-diethoxy-1′H-[2,2′;6′,2″]terpyridin-4′-one can be obtained in the form of a white, crystalline powder by chromatography on silica gel (chloroform/-methanol 9:1, 0.1% NH₄OH).

¹H-NMR (360 MHz, CDCl₃): 1.37 (t, 6H, 7.2 Hz); 4.05 (q, 4H, 7.2 Hz); 6.77 (dd, 2H, J=5.9, 2.3 Hz), 6.99 (br s, 2H, 7.30 (br s, 2H); 8.42 (d, 2H, J=5.9 Hz).

MS (EI pos., 70 eV), m/z=337 (75, [M⁺]); 322 (90); 309 (100); 281 (75); 28 (85).

### Example 27

### 4,4″-Di-pyrrolidin-1-yl-1′H-[2,2′;6′,2″]terpyridin-4′-one (hereinafter called L18)

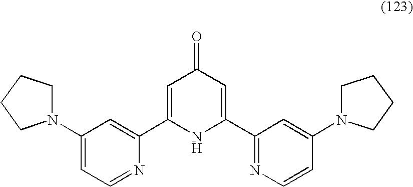

This compound is prepared in a manner analogous to that described in Example 1, Step 2, except that, instead of pyrid-2-yl-pentane-1,3,5-trione, the pyrrolidine-substituted triketone from Example 22 is employed. Pure 4,4″-di-pyrrolidin-1-yl-1′H-[2,2′;6′,2″]terpyridin-4′-one can be obtained in the form of an almost colorless solid by recrystallisation from methanol.

¹H-NMR (360 MHz, CDCl₃):1.81-2.05 (m, 8H); 3.17-3.33 (m, 8H); 6.32 (dd, 2H, J=5.7, 2.3 Hz); 6.84 (d, 2H, J=2.3 Hz); 6.90 (s, 2H); 8.19 (d, 2H, J=5.7 Hz).

MS (EI pos., 70 eV), m/z=387 ([M⁺]), 359 (100); 358 (85); 330 (20); 28 (60).

That compound can also be obtained by heating pyrrolidine and 4,4″-dichloro-1′H-[2,2′;6′,2″]terpyridin-4′-one, if desired in the presence of metal salts (see, for example, Example 6).

### Example 28

### 4,4″-Bis[(2-hydroxy-ethyl)-methyl-amino]-1′H-[2,2′;6′,2″]terpyridin-W-one (hereinafter called L19)

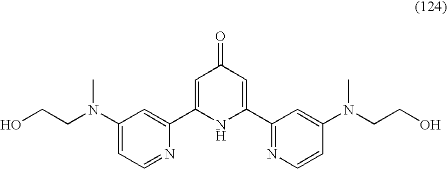

This compound is prepared in a manner analogous to that described in Example 6 for 4′-pyrrolidin-1-yl-[2,2′;6′,2″]terpyridine except that 2-(N-methylamino)ethanol is used as amine and 4,4″-dichloro-1′H-[2,2′;6′,2″]terpyridin-4′-one from Example 25 is used as precursor.

¹H-NMR (360 MHz, DMSO-d₆): 3.12 (s, 6H); 3.20-4.00 (m, 8H); 6.73-6.82 (m, 2H); 7.70-7.95 (m, 4H); 8.23 (d, 2H, 5.9 Hz).

### Example 29

### 4,4″-Diethoxy-4′-methoxy-[2,2′;6′,2″]terpyridine (hereinafter called L20)

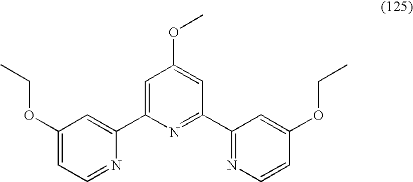

Under an argon atmosphere, 506 mg (1.5 mmol) of 4,4″-diethoxy-1′H-[2,2′;6′,2″]terpyridin-4′-one (L17, Example 26) are added at 0° C. to a suspension of 78 mg (approx. 60% dispersion in paraffin oil, 1.95 mmol) of sodium hydride in 15 ml of absolute N,N-dimethylformamide. Stirring is then carried out for 15 minutes in each case at 0° C. and at room temperature. After cooling again, 0.12 ml (1.95 mmol) of methyl iodide is added. Stirring is then carried out for a further 45 minutes at room temperature. 15 ml of water are added and filtration is carried out, yielding 4,4″-diethoxy-4′-methoxy-[2,2′;6′,2″]terpyridine in the form of a beige powder.

¹H-NMR (360 MHz, CDCl₃): 1.39 (t, 6H, J=7.2 Hz); 3.90 (s, 3H); 4.12 (q, 4H, J=7.2 Hz); 6.73 (dd, 2H, J=5.6, 2.5 Hz); 7.88 (s, 2H); 8.01 (d, 2H, J=2.5 Hz); 8.39 (d, 2H, 5.6 Hz).

MS (EI pos, 70 eV), m/z=351 (90, [M⁺]); 350 (70); 336 (100); 323 (70); 295 (45).

### Example 30

### 4′-Methoxy-4,4″-di-pyrrolidin-1-yl-[2,2′;6′,2″]terpyridine (hereinafter called L21)

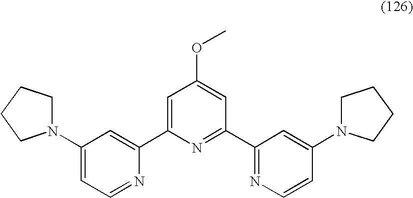

Under argon, 26 mg of sodium hydride dispersion (60%, 0.65 mmol) are suspended in 5 ml of absolute N,N-dimethylformamide and cooled to 0° C. 193 mg (0.5 mmol) of 4,4″-di-pyrrolidin-1-yl-1′H-[2,2′;6′,2″]terpyridin-4′-one (L18 from Example 27) are then added. The yellow suspension is stirred for 30 minutes at 0° C. and then warmed to room temperature for 15 minutes and cooled again. A solution of 40 μl (0.65 mmol) of methyl iodide is added. Stirring is then carried out for a further 45 minutes, and the precipitate that is formed is filtered off and recrystallised from methanol. 4′-Methoxy-4,4″-di-pyrrolidin-1-yl-[2,2′;6′,2″]terpyridine is obtained in the form of a white solid.

¹³C-NMR (90 MHz, CDCl₃): 168.1 (quat.); 157.9 (quat.); 156.6 (quat.); 152.9 (quat.); 149.5 (tert.); 107.4 (tert.); 107.1 (tert.); 105.0 (tert.); 55.9 (prim.); 47.3 (sec.); 25.8 (sec.).

MS (EI, 70 eV), m/z: 401 (50, [M⁺]); 373 (80); 372 (100); 332 (20); 28 (40).

### Example 31

### 4,4′,4″-Trichloro-[2,2′;6′,2″]terpyridine (hereinafter called L22)

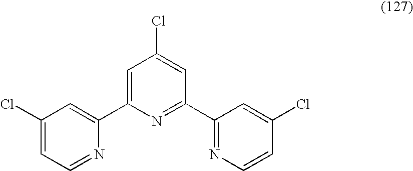

This compound is prepared In a manner analogous to that described in Example 2, except that, instead of 1′H-[2,2′;6′,2″]terpyridin-4′-one, the dichloro-substituted pyridone L16 from Example 25 is employed. 4,4′,4″-Trichloro-[2,2′;6′,2″]terpyridine, white solid. ¹H-NMR (90 MHz, CDCl₃): 7.24-7.31 (m, 2H), 8.38 (s, 2H); 8.45 (d, 2H, 1.8 Hz); 8.48 (d, 2H, 5.0 Hz).

### Example 32

### 4,4′,4″-Triethoxy-[2,2′;6′,2″]terpyridine (hereinafter called L23)

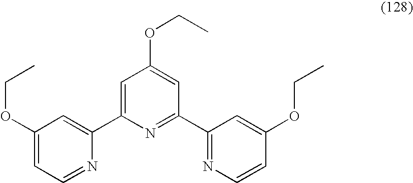

53 mg (0.15 mmol) of 4,4′,4″-trichloro-[2,2′;6′,2″]terpyridine from Example 31 is added to 2.5 ml of a 0.72 molar ethanolic solution. The mixture is heated to reflux for 2 hours, allowed to cool, 2.5 ml of water are added and 4,4′,4″-triethoxy-[2,2′;6′,2″]terpyridine is filtered off in the form of a pale-pink powder.

¹³C-NMR (90 MHz, CDCl₃): 167.4 (quat); 166.2 (quat.); 158.4 (quat.); 157.1 (quat.); 150.7 (tert.); 110.6 (tert.); 108.1 (2 signals, tert.); 64.2 (sec.); 64.1 (2 signals, sec.); 15.0 (3 signals, prim.).

### Example 33

### 4,4′,4″-Tri-pyrrolidin-1-yl-[2,2′;6′,2″]terpyridine (hereinafter called L24)

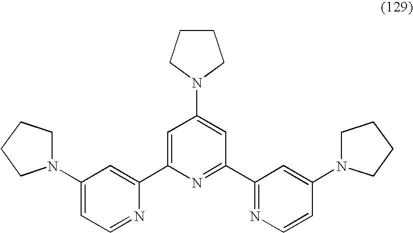

This compound is prepared in a manner analogous to that described in Example 7 except that, instead of 4′-chloro-[2,2′;6′,2″]terpyridine, the trichloro-substituted terpyridine L22 from Example 31 is employed, and pyrrolidine is used as the amine component. 4,4′,4″-Tri-pyrrolidin-1-yl-[2,2′;6′,2″]terpyridine, beige powder.

MS (EI pos., 70 eV), m/z=440 (50, [M+]); 412 (80); 411 (100); 371 (20); 220 (20), 28 (15).

IR (cm⁻¹): 2850 (w); 1608 (vs); 1537 (s); 1515 (m); 1480 (m); 1458 (m); 1019 (m); 799 (m).

### Example 34

### 2-({4′,4″-Bis[(2-hydroxy-ethyl)-methyl-amino]-[2,2′;6′,2″]terpyridin-4-yl}-methyl-amino)-ethanol (hereinafter called L25)

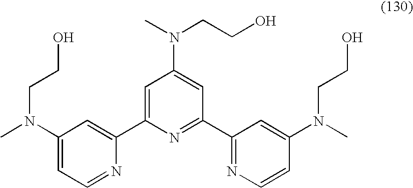

This compound is prepared in a manner analogous to that described in Example 7 except that, instead of 4′-chloro-[2,2′;6′,2″]terpyridine, the trichloro-substituted terpyridine L22 from Example 31 is employed and 2-methylaminoethanol is used as the amine component. 2-({4,4″-Bis[(2-hydroxy-ethyl)-methyl-amino]-[2,2′;6′,2″]terpyrid-4-yl}methyl-amino)-ethanol, white solid.

¹³C-NMR (90 MHz, DMSO₆): 156.4 (quat.); 155.7 (quat.); 155.3 (quat.); 154.4 (quat.); 149.2 (tert.); 106.7 (tert.); 103.4 (tert.); 103.1 (tert.); 58.4 (2 signals, sec.); 58.2 (sec.); 53.6 (sec.); 53.5 (2 signals, sec.); 38.6 (prim.); 38.3 (2 signals, prim.).

### Example 35

### 4′-Chloro-4,4″-diethoxy-[2,2′;6′,2″]terpyridine (hereinafter called L26)

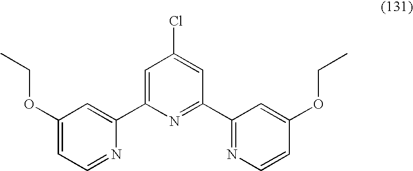

This compound is prepared in a manner analogous to that described in Example 2, except that, instead of 1′H-[2,2′;6′,2″]terpyridin-4′-one, the diethoxy-substituted pyridone L17 from Example 26 is employed. 4′-Chloro-4,4″-diethoxy-[2,2′;6′,2″]terpyridine, white solid.

¹³C-NMR (90 MHz, CDCl₃): 166.3 (quat.); 157.0 (quat.); 156.9 (quat.); 150.8 (tert.); 146.5 (quat.); 121.7 (tert); 110.8 (tert.); 108.4 (tert.); 64.2 (sec.); 14.9 (prim.).

### Example 36

### 4,4″-Diethoxy-4′-pyrrolidin-1-yl-[2,2′;6′,2″]terpyridine (hereinafter called L27)

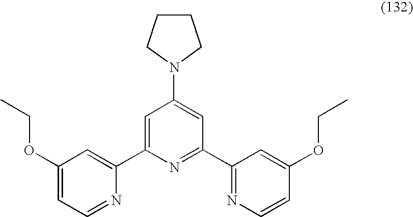

This compound is prepared in a manner analogous to that described in Example 7 except that, instead of 4′-chloro-[2,2′;6′,2″]terpyridine, the chloro-substituted terpyridine L26 from Example 35 and pyrrolidine are used as the amine component. 4,4″-Diethoxy-4′-pyrrolidin-1-yl-[2,2′;6′,2″]terpyridine, white solid.

¹³C-NMR (90 MHz, CDCl₃): 166.2 (quat.); 159.4 (quat.); 157.1 (quat.); 155.6 (quat.); 150.4 (tert.); 110.5 (tert.); 107.9 (tert.); 104.8 (tert.); 63.9 (sec.); 47.8 (sec.); 25.8 (sec.); 15.0 (prim.).

MS (EI pos., 70 eV), m/z)=390 (100, [M⁺]); 333 (70); 305 (20); 28 (25).

### Example 37

### 2-[(4,4″-Diethoxy-[2,2′;6′,2″]terpyrid-4′-yl)-(2-hydroxy-ethyl)-amino]-ethanol (hereinafter called L28)

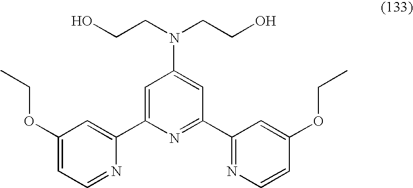

This compound is prepared in a manner analogous to that described in Example 7 except that, instead of 4′-chloro-[2,2′;6′,2″]terpyridine, the chloro-substituted terpyridine L26 from Example 35 is used as the amine component. Recrystallisation from methanol yields 2-[(4,4″-diethoxy-[2,2′;6′,2″]terpyrid-4′-yl)-(2-hydroxy-ethyl)-amino]-ethanol in the form of a white solid.

¹³C-NMR (90 MHz, CDCl₃): 165.5 (quat.); 158.0 (quat.); 155.0 (quat.); 154.6 (quat.); 150.6 (tert.); 110.4 (tert.); 107.0 (tert.); 103.5 (tert.); 63.6 (sec.); 57.9 (sec.); 52.7 (sec.); 14.5 (prim.).

### Example 38

### 6,6″-Bis(2-methoxyphenyl)-2,2′:6′:2″-terpyridine (hereinafter called L29)

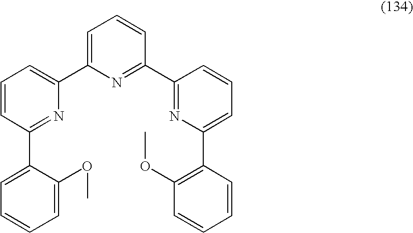

A solution of 7.6 g (24 mmol) of caesium carbonate in 8 ml of water is added to a solution of 0.9 g (2.3 mmol) of 6′6″-dibromo-2,2′:6′,2″-terpyridine in 14 ml of dimethoxyethane. 8.9 mg (0.02 mmol) of μ-bromo(triisopropylphosphine)(η³-allyl)palladium(II) (see WO-A-99/47474) and 0.89 g (5.88 mmol) of 2-methoxyphenylboronic acid are added. Heating at reflux under argon is then carried out for 10 hours. The mixture is cooled, the phases are separated, and the organic extract is extracted three times with ethyl acetate. The organic phase is dried over sodium sulfate, filtered and concentrated. The crude product is chromatographed (silica gel, hexane/ethyl acetate 10:1). 6,6″-Bis(2-methoxyphenyl)-2,2′:6′:2″-terpyridine, white solid.

¹³C-NMR (90 MHz, CDCl₃): 157.7 (quat.); 155.7 (quat.); 155.3 (quat.); 138.2 (tert.); 137.1 (tert.); 131.9 (tert.); 130.5 (tert.); 129.3 (quat.); 125.6 (tert.); 121.6 (tert.); 121.5 (tert.); 119.5 (tert); 112.0 (tert.); 56.1 (prim.).

### Example 39

### 6,6″-Bis(2-hydroxyphenyl)-2,2′:6′,2″-terpyridine (hereinafter called L30)

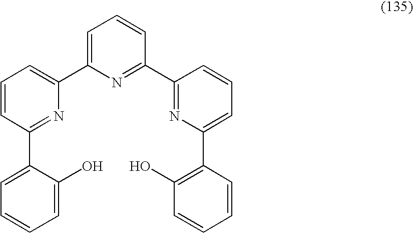

At −75° C., 1.12 g (4.49 mmol) of boron tribromide, dissolved in 5 ml of dichloromethane, are added dropwise to a solution of 200 mg (0.448 mmol) of 6,6″-bis(2-methoxyphenyl)-2,2′:6′:2″-terpyridine (L29, Example 38) in 15 ml of dichloromethane. After one hour, the cooling bath is removed and the solution is stirred for 10 hours at room temperature. The solution is poured into ice-water and neutralised with sodium hydrogen carbonate solution. Extraction is carried out twice with dichloromethane, and the combined organic extracts are dried over sodium sulfate, filtered and concentrated. The crude product is chromatographed (silica gel, dichloromethane/methanol 20:1). 6,6″-Bis(2-hydroxyphenyl)-2,2′:6′,2′-terpyridine, white solid. ¹³C-NMR (90 MHz, CDCl₃): 160.2 (quat.); 157.7 (quat.); 154.5 (quat.); 153.1 (quat.); 139.4 (tert.); 139.2 (tert.); 132.1 (tert.); 130.2 (quat.); 126.9 (tert.); 121.9 (tert); 121.6 (tert.); 120.0 (tert.); 119.5 (tert.); 119.2 (tert.); 118.9 (tert.).

### Example 40

### 4-Chloro-1′H-[2,2′;6′,2″]terpyridin-4′-one (hereinafter called L31)

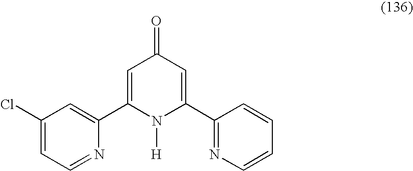

110 ml of 25% ammonium hydroxide solution are added to 1-(4-chloro-pyrid-2-yl)-5-pyrid-2-yl-pentane-1,3,5-trione (for preparation see Example 24) in 100 ml of isopropanol and refluxed for 4.5 hours. At room temperature, the mixture is adjusted to pH 5 using 6N hydrochloric acid and filtered. The residue is filtered over silica gel (eluant: chloro-form/methanol/ammonium hydroxide solution 4:1:0.1), filtered and concentrated. After recrystallisation from acetone, 4-chloro-1′H-[2,2′;6′,2″]terpyridin-4′-one is obtained in the form of a grey solid, which is further processed without special purification steps.

¹H-NMR (360 MHz, DMSO-d₆): 8.72-8.63 (m, 2H); 8.62-8.53 (m, 2H); 7.98 (ddd, 1H, J=7.7,7.7,1.8 Hz); 7.87 (d, 1H, J=2.2 Hz); 7.83 (d, 1H, J=2.2 Hz); 7.59 (dd, 1H, J=5.4,2.2 Hz); 7.43-7.51 (m, 1H); 2.07 (s, 1H).

### Example 41

### 4-(4-Methyl-piperazin-1-yl)-1′H-[2,2′;6′,2″]terpyridin-4′-one (hereinafter called L32)

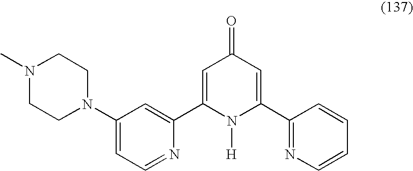

A mixture of 5.22 g (18.4 mmol) of 4-chloro-1′H-[2,2′;6′,2″]terpyridin-4′-one (L31 in Example 40),18.36 g (184 mmol, 20.4 ml) of 1-methyl-piperazine and 125 mg (0.92 mmol, 0.05 equivalent) of zinc(II) chloride in 80 ml of 2-methyl-2-butanol is refluxed for 30 hours and concentrated to dryness using a rotary evaporator. 100 ml of water are added and the mixture is rendered neutral using concentrated hydrochloric acid. After extraction four times with chloroform, and combining and drying (sodium sulfate) the organic extracts, the crude product is obtained, which is then recrystallised from acetonitrile. 4-(4-Methyl-piperazin-1-yl)-1′H-[2,2′;6′,2″]terpyridin-4-one is obtained in the form of a white solid.

¹H-NMR (360 MHz, CDCl₃): 8.69 (d, 1H, 4.5 Hz); 8.32 (d, 1H, J=5.9 Hz); 7.92-7.74 (m, 2H); 7.37-7.30 (m, 1H); 7.20 (d, 1H, J=2.3 Hz); 7.01 (s, 1H); 6.98 (s, 1H); 6.71-6.63 (m, 1H); 3.45-3.35 (tm, 4H); 2.58-2.48 (tm, 4H); 2.32 (s, 3H).

### Example 42

### 1,1-Dimethyl-4-(4′-oxo-1′,4′-dihydro-[2,2″;6′,2″]terpyrid-4-yl)-piperazin-1-ium methosulfate ((hereinafter called L33))

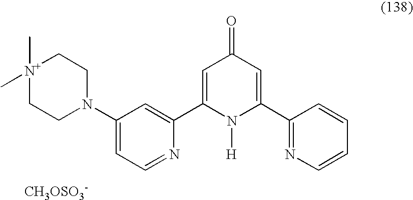

0.33 ml (3.5 mmol, 442 mg) of dimethyl sulfate is added dropwise to a suspension of 1.22 g (3.5 mmol) of 4-(4-methyl-piperazin-1-yl)-1′H-[2,2′;6′,2″]terpyridin-4′-one (L32 in Example 41) In 60 ml of acetone. After 17 hours, filtration is carried out and the crude product is washed (acetone and dichloromethane) and then recrystallised from methanol. 1,1-Dimethyl-4-(4′-oxo-1′,4′-dihydro-[2,2′;6′,2″]terpyrid-4-yl)-piperazin-1-ium methosulfate is obtained in the form of a white solid.

C₂₂H₂₇N₅O₅S*0.09H₂O, 475.17; calculated C 55.61H 5.77 N 14.74 S 6.75H₂O 0.34; found C 55.56H 5.85 N 14.63 S 6.75H₂O 0.33.

¹H-NMR (360 MHz, D₂O): 8.31 (d, 1H, J=4.1 Hz); 7.76 (dd, 1H, J=7.7); 7.64 (d, 1H, J=7.7 Hz); 7.58 (d, 1H, J=5.4 Hz); 7.22 (dd, 1H, J=7.2,5.0 Hz), 6.71 (s, 1H, 6.48 (dm, ₁H); 6.46-6.39 (dm, 1H); 6.34 (dm, 1H); 3.67 (s, 3H); 3.48 (br s, 8H); 3.19 (s, 6H).

### Example 43

### 4,4″-Bis(4-methyl-piperazin-1-yl)-1′H-[2,2′;6′,2″]terpyridin-4′-one (hereinafter called L34)

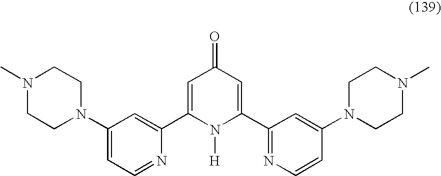

A mixture of 10.89 g (34.2 mmol) of 4,4″-dichloro-1′H-[2,2′;6′,2″]terpyridin-4′-one (L16 in Example 25), 68.6 g (685 mmol, 76.1 ml) of 1-methyl-piperazine and 233 mg (1.71 mmol, 0.05 equivalent) of zinc(II) chloride in 200 ml of 2-methyl-2-butanol is refluxed for 24 hours and concentrated to dryness using a rotary evaporator. The crude product is recrystallised from ethyl acetate/methanol 33:1 (vtv), taken up in 100 ml of water and adjusted to pH 8-9 using 4N sodium hydroxide, and light-beige 4,4″-bis(4-methyl-piperazin-1-yl)-1′H-[2,2′;6′,2″]terpyridin-4′-one is filtered off.

¹H-NMR (360 MHz, CDCl₃): 8.32 (d, 2H, J=5.9 Hz); 7.18 (dm, 2H); 6.93 (s, 2H); 6.66 (dd, 2H; J=5.9,2.3 Hz); 3.41-3.32 (tm, 8H); 2.55-2.44 (tm, 8H); 2.29 (s, 6H).

### Example 44

### Twofold quaternisation of 4,4″-bis(4-methyl-piperazin-1-yl)-1′H-[2,2′;6′,2″]terpyridin-4′-one mit methyl iodide (hereinafter called L35)

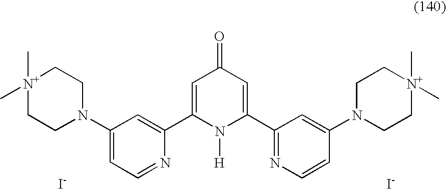

8.7 ml (19.9 g, 140 mmol) of methyl iodide are added dropwise to a suspension of 3.12 g (7 mmol) of 4,4′-bis(4-methyl-piperazin-1-yl)-1′H-[2,2′;6′,2″]terpyridin-4′-one (L34 In Example 43) in 150 ml of acetonitrile. Stirring for 5 hours at room temperature and filtration are carried out, and the resulting twofold-quaternised, whitish 4,4″-bis(4-methyl-piperazin-1-yl)-1′H-[2,2′;6′,2″]terpyridin-4′-one (C₂₇H₃₇I₂N₇O) is washed (acetonitrile).

¹H-NMR (360 MHz, D₂O): 7.73 (d, 2H, J=5.9 Hz); 6.88 (s, 2H); 6.63-6.54 (dm, 2H); 6.45 (s, 2H); 3.69-3.43 (dm, 16H); 3.20 (s, 12H).

### Example 44a

### Threefold methylation of 4,4″-bis(4-methyl-piperazin-1-yl)-1′H-[2,2′;6′,2″]terpyridin-4′-one with methyl iodide (ligand L35a)

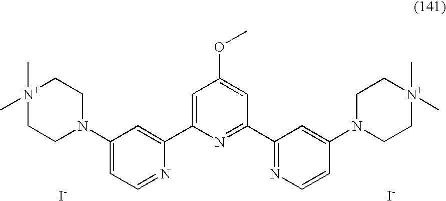

156 mg (0.35 mmol) of 4,4″-bis(4-methyl-piperazin-1-yl)-1′H-[2,2′;6′,2″]terpyridin-4′-one (L34 in Example 43) are added at 4CC to a suspension of a total of approx. 30 mg of sodium hydride (approx. 0.75 mmol, 60% in mineral oil) in 3 ml of absolute N,N-dimethylformamide. The mixture is stirred for 20 minutes at that temperature, heated at room temperature for one hour, and cooled again. 66 μl (1.05 mmol) of methyl iodide are then added dropwise, and the mixture is stirred for 20 minutes with cooling and for 30 minutes at room temperature. After cooling again and adding 2 ml of water, white, threefold-methylated 4,4″-bis(4-methyl-piperazin-1-yl)-1′H-[2,2′;6′,2″]terpyridin-4′-one of formula C₂₈H₃₉I₂N₇O is filtered off.

¹³C-NMR (40 MHz, DMSO-d₆): 167.2; 156.8; 155.6; 154.7; 149.8; 109.4; 106.4; 105.6; 59.9; 55.5; 50.4; 40.0.

### Example 45

### Anion exchange in L35 (ligand L36)

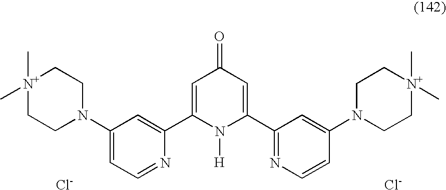

0.96 g (1.32 mmol) of 4,4″-bis(4-methyl-piperazin-1-yl)-1′H-[2,2′;6′,2″]terpyridin-4′-one, twofold-quaternised with methyl iodide, is dissolved in 10 ml of dilute HCl (pH=6). The solution Is eluted through an ion exchange column (100 g of DOWEX 1×8, 200-400 mesh, chloride form) and concentrated using a rotary evaporator.

C₂₇H₃₇Cl₂N₇O*1.8 HCl*2H₂O, calculated C 50.03H 6.66 N 15.13 Cl 20.78, found C 50.47H 6.67 N 14.90 Cl 20.4 (Iodine content<0.3).

¹H-NMR (400 MHz, D₂O): 8.17 (dm, 2H, J=7 Hz); 7.59 (s, 2H); 7.46 (s, 2H); 7.15 (dm, 2H, J=7 Hz); 4.14 (br s, OH); 3.71 (br s, 8H); 3.30 (s, 12H).

### Example 46

### Twofold quaternisation of 4,4″-bis(4-methyl-piperazin-1-yl)-1′H-[2,2′;6′,2″]terpyridin-4′-one with dimethyl sulfate (ligand L37)

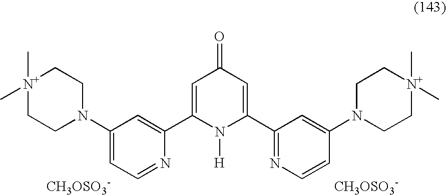

2.66 ml (27.92 mmol) of dimethyl sulfate are added dropwise to a suspension of 6.22 g (13.96 mmol) of 4,4″-bis(4-methyl-piperazin-1-yl)-1′H-[2,2′;6′,2″]terpyridin-4′-one (L34 in Example 43) in 250 ml of acetone. After 20 hours, twofold quaternised whitish 4,4″-bis(4-methyl-piperazin-1-yl)-1′H-[2,2′;6′,2″]terpyridin-4′-one is filtered off and washed (acetone). C₂₉H₄₃N₇O₉S₂*0.39H₂O, 704.86; calculated C 49.42H 6.26 N 13.91 S 9.10H₂O 1.00; found C 49.30H 6.19 N 13.85 S 8.99H₂O 1.00.

¹H-NMR (360 MHz, D₂O): 8.08 (d, J=5.9 Hz, 2H); 7.18 (dm, 2H); 6.79 (dd, J=5.9,2.3 Hz); 6.74 (s, 2H); 3.77-3.68 (m, 8H); 3.65 (s, 6H); 3.59-3.50 (m, 8H).

Synthesis of Metal Complexes with Terpyridine Ligands and 4-Pyridone Ligands

### Example 47

### Manganese(II) complex with a pyridone ligand: {([2,2′;6′,2″]terpyridin-4′-ol}manganese(II) chloride

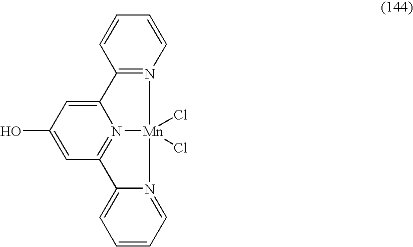

198 mg (1 mmol) of manganese(II) chloride tetrahydrate are dissolved in 10 ml of ethanol, and 249 mg (1 mmol) of 1′H-[2,2′;6′,2″]terpyridin-4′-one L1 are added. The mixture is stirred for 24 hours at room temperature and filtered and the light-yellow solid is dried in vacuo. C₁₅H₁₁Cl₂MnN₃O, 375.12; calculated C 48.03H 2.96 N 11.20 Mn 14.65, found C 48.22H 3.14 N 11.13 Mn 14.6.

IR (cm⁻¹): 3082 (br, vs), 1613 (s), 1600 (s), 1558 (s), 1429 (m), 1224 (s), 1011 (m), 798 (m).

### Example 48

### Manganese(II) complex with a substituted terpyridine ligand: {2-[(2-hydroxy-ethyl)-[2,2′;6′,2″]terpyrid-4′-yl-amino]-ethanol}manganese(II) chloride

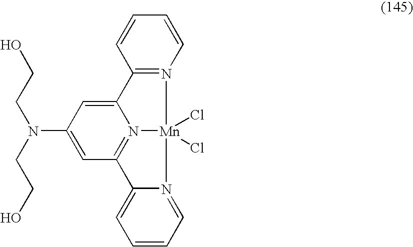

336 mg (1 mmol) of 2-[(2-hydroxy-ethyl)-[2,2′;6′,2″]terpyrid-4′-yl-amino]-ethanol L7, dissolved in 5 ml of water, are added dropwise to 5 ml of an aqueous solution of 198 mg (1 mmol) of manganese(II) chloride tetrahydrate. The mixture is stirred for 20 minutes at room temperature and filtered and the light-yellow solid is dried in vacuo.

C₁₉H₂₀Cl₂MnN₄O₂*0.11H₂O; calculated C 49.16 H 4.39 N 12.07 Mn 11.83, found C 49.23H 4.38 N 12.07 Mn 12.1.

IR (cm⁻¹): 3512 (w), 3456 (m), 1609 (vs), 1569 (w), 1518 (s), 1532 (w), 1569 (w), 1473 (w), 1444 (s), 1055 (w), 1055 (s), 1013 (vs), 789 (vs).

### Example 49

### Manganese(II) complex with two substituted terpyridine ligands: bis{2-[(2-hydroxy-ethyl)-[2,2′;6′,2″]terpyrid-4′-yl-amino]-ethanol}manganese(II) chloride

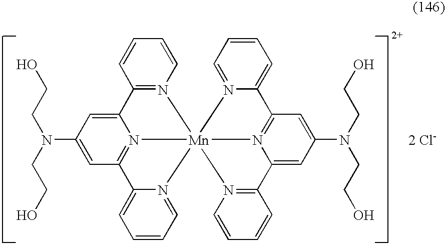

336 mg (1 mmol) of 2-[(2-hydroxy-ethyl)-[2,2′;6′,2″]terpyrid-4′-yl-amino]-ethanol L7 are suspended in 5 ml of ethanol/water, and an ethanolic solution of 99 mg (0.5 mmol) of manganese(II) chloride tetrahydrate is added. The mixture is then stirred at room temperature for 90 minutes and the orangeish-yellow solid is filtered off and dried. C₃₈H₄₀Cl₂MnN₈O₄*H₂O, calculated C 55.89H 5.18 N 13.72 Mn 6.73, found C 56.08H 5.44 N 13.58 Mn 6.66.

IR (cm⁻¹): 3240 (br), 1598 (vs), 1570 (w), 1510 (m), 1473 (m), 1442 (s), 1046 (w), 1011 (vs), 792 (w).

Modification of Manganese-Bonded, Substituted Terpyridine-Type Ligands, Direct Complex Synthesis: (Example 50)

### Example 50

### Bis{4,4″-bis[(2-hydroxy-ethyl)-methyl-amino]-[2,2′;6′,2″]terpyridin-4′-ol}manganese(II) chloride

318 mg (1 mmol) of L16 in 25 ml of methanol is heated at reflux for 18 hours, under argon, with 426 mg (2.2 mmol) of manganese(II) chloride tetrahydrate and 8.8 g (117 mmol) of N-methylaminoethanol. Concentration is carried out, and the residue is chromatographed on silica gel (dichloromethane/methanol 4:1).

C₄₂H₅₀Cl₂MnN₁₀O₆, yellow solid.

IR (cm⁻¹): 3238 (br, m), 1603 (vs) 1511 (s), 1536 (m), 1484 (m), 1450 (m), 1356 (w), 1010 (s).

### Example 51

### Manganese(II) complex with 1,1-dimethyl-4-(4′-oxo-1′,4′-dihydro-[2,2′;6′,2″]terpyrid-4-yl)-piperazin-1-ium methosulfate

A solution of 37.6 mg (0.19 mmol) of manganese(II) chloride tetrahydrate in 4 ml of methanol is added to a suspension of 1,1-dimethyl-4-(4′-oxo-1′,4′-dihydro-[2,2′;6′,2″]terpyrid-4-yl)-piperazin-1-ium methosulfate(L33 in Example 42) in 4 ml of methanol. Concentration using a rotary evaporator (30° C., 20 mbar final pressure) is then carried out. The manganese complex of formula C₂₂H₂₇Cl₂MnN₅O₅S*0.38H₂O (Fw=606.24) is obtained in the form of a yellow powder; calculated C 43.59H 4.62 N 11.55 S 5.29 Cl 11.70 Mn 9.06H₂O 1.13; found C 43.54H 4.50 N 11.73 S 5.07 Cl 11.69 Mn 9.06H₂O 1.14.

### Example 52

### Manganese complex with 4,4″-bis(4-methyl-piperazin-1-yl)-1′H-[2,2′;6′,2″]terpyridin-4′-one

One equivalent of ligand L34 (Example 43) hydrochloride is added to a solution of 2.33 g (11.8 mmol) of manganese(II) chloride tetrahydrate in 100 ml of water. The solution is then freeze-dried. The manganese complex of formula C₂₅H₃₁Cl₂MnN₇O*3.73H₂O*2.31 HCl is obtained in the form of a yellow solid. Calculated C 46.06H 6.30 N 15.04 Cl 12.56 Mn 8.43H₂O 10.31, found C 46.02H 5.84 N 14.99 Cl 12.54 Mn 8.17H₂O 10.52.

### Example 53

### Manganese complex with twofold-quaternised 4,4″-bis(4-methyl-piperazin-1-yl)-1′H-[2,2′;6′,2″]terpyridin-4′-one

One equivalent of ligand L37 (Example 46) is added to a solution of 2.64 g (13.33 mmol) of manganese(II) chloride tetrahydrate in 350 ml of water. The solution is then freeze-dried. The manganese complex of formula C₂₉H₄₃Cl₂MnN₇O₉S₂.3.62H₂O is obtained in the form of a yellow solid. Calculated C 39.19H 5.70 N 11.03 Cl 7.98 Mn 6.18H₂O 7.34, found C 38.68H 5.65 N 10.73 Cl 7.77 Mn 5.97H₂O 7.33.

### Example 53a

### Manganese(II) complex with twofold-quaternised 4,4″-bis(4-methyl-piperazin-1-yl)-1′H-[2,2′;6′,2″]terpyridin-4′-one

A solution of 119 mg (0.6 mmol) of manganese(II) chloride tetrahydrate in 11 ml of methanol is added to a suspension of 419 mg (0.6 mmol) of ligand C₂₉H₄₃N₇O₉S₂ (L37 in Example 46). Concentration is then carried out using a rotary evaporator (30° C., 20 mbar final pressure). The manganese complex of formula C₂₉H₄₃Cl₂MnN₇O₉S₂*2.22H₂O (Fw 863.67) is obtained in the form of a yellow powder; calculated C 40.33H 5.54 N 11.35 S 7.43 Cl 8.21 Mn 6.36H₂O 4.63; found C 41.10H 5.35 N 11.77 S 7.18 Cl 8.36 Mn 5.91H₂O 4.64.

Synthesis of Higher-Valent Manganese Complexes with Substituted Ligands of the Terpyridine Type (Examples 54 to 57) [Compare Method by J. Limburg et al., Science 1999, 283, 1524-1527 for Terpyridine]:

### Example 54

1.78 g (7.14 mmol) of 1′H-[2,2′;6′,2″]terpyridin-4′-one L1 are added to a solution of 1.75 g (7.14 mmol) of manganese(II) acetate tetrahydrate in 35 ml of water. A solution of 3.28 g (9.93 mmol of active oxygen in the form of KHSO₅) of potassium peroxomonosulfate in 20 ml of water is then added dropwise. The mixture is subsequently stirred for 2 hours at room temperature, then filtered off with suction and washed with 25 ml of water. Drying is carried out for 12 hours at 50° C. in vacuo to yield 2.05 g of olive-green powder. IR (cm⁻¹): 3068 (m), 1613 (m), 1602 (m), 1587 (s), 1480 (m), 1099 (vs), 1053 (w), 1028 (s), 1011 (s), 788 (m).

### Example 55

1.23 g (5 mmol) of manganese(II) acetate tetrahydrate are added to a suspension of 1.68 g (5 mmol) of 2-[(2-hydroxy-ethyl)-[2,2′;6′,2″]terpyridin-4′-yl-amino]-ethanol L7. A solution of 1.44 g (4.37 mmol of active oxygen in the form of KHSO₅) of potassium peroxomonosulfate in 30 ml of water is then added dropwise. A total of 25 ml of 1 M ammonium hexafluorophosphate solution are added dropwise to the now red solution. The precipitate is filtered off and washed twice with 10 ml of water each time. The red solid is then taken up in 30 ml of acetonitrile, filtered through a paper filter and concentrated. The residue remaining is extracted with dichloromethane for 16 hours in a Soxhlet apparatus and then dried in vacuo at 50° C. 2.15 g of wine-red powder are obtained.

IR (cm⁻¹): 2981 (s), 2923 (s), 2866 (m), 2844 (m), 1621 (s), 1571 (w), 1537 (w), 1475 (s), 1356 (m), 1055 (s), 1032 (vs), 1011 (s), 829 (vs), 784 (s), 740 (w).

### Example 56

99 mg (0.5 mmol) of manganese(II) chloride tetrahydrate are added to a suspension of 168 mg (0.5 mmol) of 2-[(2-hydroxy-ethyl)-[2,2′;6′,2″]terpyrid-4′-yl-amino]-ethanol L7. A solution of 144 mg (0.44 mmol of active oxygen in the form of KHSO₅) of potassium peroxomonosulfate in 3 ml of water is then added dropwise. The almost black solid is filtered off and dried in vacuo at 50° C.

IR (cm⁻): 3324 (br, m), 3076 (br), 1614 (s), 1523 (w), 1476 (m), 1154 (w), 1055 (w), 1025 (vs), 925 (w), 647 (s).

### APPLICATION EXAMPLES

### Application Example 1

### Bleaching of Morin in Solution

10 μM catalyst solution (1:1 complex of Mn(II) chloride tetrahydrate with the ligand in question in water or methanol) are added at time t=0 to a solution of 160 μM morin in 10 mM carbonate buffer, pH 10. The solution is located in a thermostatically controllable vessel, equipped with a magnetic stirrer, at 40° C. The extinction of the solution is measured at 410 nm over a period of 50 min. The values for the decoloration after a test duration of 5 min. are indicated as percentages:

TABLE 1

| | Extent of the decoloration |
|---|---|
| Ligand | after 5 min (%) |
| L1 | 48 |
| L5 | 36 |
| L6 | 20 |
| L19 | 79 |
| L24 | 31 |
| L25 | 57 |
| L32 | 64 |
| L33 | 42 |
| L34 | 69 |
| L37 | 39 |
| 10 mM H₂O₂ | 13 |
| Reference without catalyst | 8 |

It can be seen that the bleaching action of the substances according to the invention is superior to the reference (system without catalyst) and to that of 10 mM hydrogen peroxide alone.

### Application Example 2

### Bleaching Action in Detergents

7.5 g of white cotton fabric and 2.5 g of tea-stained (BC01, CFT) cotton fabric are treated in 80 ml of washing liquor. The liquor contains a standard detergent (IEC 60456 A*) in a concentration of 7.5 g/l. The catalyst concentration (1:1 complex of manganese(II) chloride tetrahydrate with ligand L19, prepared in aqueous solution) is 20, 50 and 100 μmol/l. The washing procedure is carried out in a steel beaker in a LINITEST apparatus for 60 minutes at 40° C. To evaluate the bleaching results, the increase in lightness ΔY (difference in lightness according to CIE) of the stains brought about by the treatment is determined by reflectance measurements In comparison with values obtained without the addition of catalyst. The following increases in lightness were found:
20 μM catalyst: ΔY=0.9
50 μM catalyst: ΔY=1.1
100 μM catalyst: ΔY=2.4

### Application Example 3

### Bleaching of Tea Stains on Melamine Panels

Tea-stained melamine panels are used to illustrate the activity according to the invention of the terpyridine complexes for bleaching hard surfaces, especially kitchen surfaces. A solution containing 100 ppm of a catalyst in carbonate buffer (1:1 complex of manganese(II) chloride tetrahydrate with ligand L19,) is added to the tea stain at room temperature and left overnight. To evaluate the bleaching results, the increase in the lightness ΔY (difference in lightness according to CIE) of the stains brought about by the treatment is determined by reflectance measurements in comparison with values obtained without the addition of catalyst. In the case in question, the addition of the catalyst results in an increase in lightness of 1.1.

1. A method of catalyzing an oxidation reaction using molecular oxygen and/or air, which comprises contacting an oxidizable substrate with molecular oxygen and/or air in the presence of a catalytically effective amount of at least one metal complex compound of formula (1)
[LₙMeₘXₚ]^{z}Y_{q} (1),
wherein
Me is manganese, titanium, iron, cobalt, nickel or copper,
X is a coordinating or bridging radical,
n and m are each independently of the other an integer having a value of from 1 to 8,
p is an integer having a value of from 0 to 32,
z is the charge of the metal complex,
Y is a counter-ion,
q=z/(charge of Y), and
L is a ligand of formula (2) 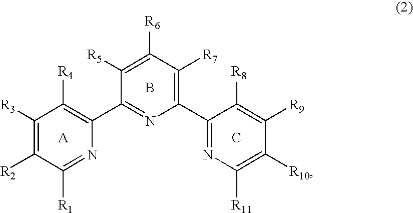
wherein
R₁, R₂, R₃, R₄, R₅, R₆, R₇, R₈, R₉, R₁₀ and R₁₁ are each independently of the others hydrogen;
unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; —SR₁₃, —SO₂R₁₃ or —OR₁₃ wherein R₁₃ is in each case hydrogen or unsubstituted or substituted C₁-C₁₈alkyl or aryl; —NR₁₄R₁₅; —(C₁-C₆alkylene)-NR₁₄R₁₅; —N^{⊕}R₁₄R₁₅R₁₆; —(C₁-C₆alkylene)-N^{⊕}R₁₄R₁₅R₁₆;
—N(R₁₃)—(C₁-C₆alkylene)-NR₁₄R₁₅; —N[(C₁-C₆alkylene)-NR₁₄R₁₅]₂; —N(R₁₃)-(C₁-C₆alkylene)-N^{⊕}R₁₄R₁₅R₁₆;
—N[(C₁-C₆alkylene)-N^{⊕}R₁₄R₁₅R₁₆]₂; —N(R₁₃)—N—R₁₄R₁₅ or —N(R₁₃)—N^{⊕}R₁₄R₁₅R₁₆ wherein R₁₃ is as defined above and R₁₄, R₁₅ and R₁₆ are each independently of the other(s) hydrogen or unsubstituted or substituted C₁-C₁₈alkyl or aryl, or R₁₄ and R₁₅, together with the nitrogen atom linking them, form an unsubstituted or substituted 5-, 6- or 7-membered ring which may contain further hetero atoms.

2. A method according to claim 1, wherein Me is manganese, which is in oxidation state II, III, IV or V.

3. A method according to claim 1, wherein
X is CH₃CN, H₂O, F⁻, Cl⁻, Br⁻, HOO⁻, O₂²⁻, O²⁻, R₁₇COO⁻, R₁₇O⁻, LMeO⁻ or LMeOO⁻, wherein R₁₇ is hydrogen or unsubstituted or substituted C₁-C₁₈alkyl or aryl, and
L and Me are as defined in claim 1.

4. A method according to claim 1, wherein
Y is R₁₇COO⁻, ClO₄⁻, BF₄⁻, PF₆⁻, R₁₇SO₃⁻, R₁₇SO₄⁻, SO₄²⁻, NO₃⁻, F⁻, Cl³¹ , Br⁻ or I⁻, wherein
R₁₇ is hydrogen or unsubstituted or substituted C₁-C₁₈alkyl or aryl.

5. A method according to claim 1, wherein
n is an integer having a value of from 1 to 4.

6. A method according to claim 1, wherein
m is an integer having a value of 1 or 2.

7. A method according to claim 1, wherein
p is an integer having a value of from 0 to 4.

8. A method according to claim 1, wherein
z is an integer having a value of from 8− to 8+.

9. A method according to claim 1, wherein aryl is phenyl or naphthyl each unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy.

10. A method according to claim 1, wherein the 5-, 6- or 7-membered ring formed by R₁₄ and R₁₅ together with the nitrogen atom linking them is an unsubstituted or C₁-C₄alkyl-substituted pyrrolidine, piperidine, piperazine, morpholine or azepane ring.

11. A method according to claim 1, wherein
R₆ is C₁-C₁₂alkyl; phenyl unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy; cyano; halogen; nitro; —COOR₁₂ or —SO₃R₁₂ wherein R₁₂ is in each case hydrogen, a cation, C₁-C₁₂alkyl, unsubstituted phenyl or phenyl substituted as indicated above; —SR₁₃, —SO₂R₁₃ or —OR₁₃ wherein R₁₃ is in each case hydrogen, C₁-C₁₂alkyl, unsubstituted phenyl or phenyl substituted as indicated above; —N(R₁₃)—NR₁₄R₁₅ wherein R₁₃ is as defined above and R₁₄ and R₁₅ are each independently of the other hydrogen, unsubstituted or hydroxy-substituted C₁-C₁₂alkyl, unsubstituted phenyl or phenyl substituted as indicated above, or R₁₄ and R₁₅, together with the nitrogen atom linking them, form an unsubstituted or C₁-C₄alkyl-substituted pyrrolidine, piperidine, piperazine, morpholine or azepane ring; —NR₁₄R₁₅ or —N^{⊕}R₁₄R₁₅R₁₆ wherein R₁₄, R₁₅ and R₁₆ are each independently of the other(s) hydrogen, unsubstituted or hydroxy-substituted C₁-C₁₂alkyl, unsubstituted phenyl or phenyl substituted as indicated above, or R₁₄ and R₁₅, together with the nitrogen atom linking them, form an unsubstituted or C₁-C₄alkyl-substituted pyrrolidine, piperidine, piperazine, morpholine or azepane ring; and
R₁, R₂, R₃, R₄, R₅, R₇, R₈, R₉, R₁₀ and R₁₁ are as defined above or are hydrogen.

12. A method according to claim 11, wherein the ligand L is a compound of formula (3) 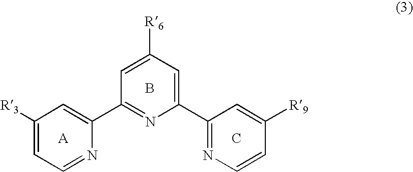
wherein
R′₃, R′₆ and R′₉ have the meanings given for R₆ in claim 11.

13. A method according to claim 12, wherein
R′₃, R′₆ and R′₉ are each independently of the others C₁-C₄alkoxy; hydroxy; phenyl unsubstituted or substituted by C₁-C₄alkyl, C₁-C₄alkoxy, phenyl or by hydroxy; hydrazine; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring.

14. A method according to claim 13, wherein
R₆ is hydroxy.

15. A method according to claim 1, wherein there is used at least one metal complex compound of formula (1′)
[L′ₙMeₘXₚ]^{z}Y_{q} (1′),
wherein
Me is manganese, titanium, iron, cobalt, nickel or copper,
X is a coordinating or bridging radical,
n and m are each independently of the other an integer having a value of from 1 to 8,
p is an integer having a value of from 0 to 32,
z is the charge of the metal complex,
Y is a counter-ion,
q=z/(charge of Y), and
L′ is a ligand of formula (2′) 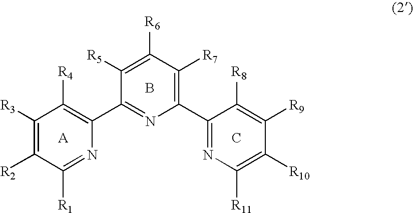
wherein
R₁, R₂, R₃, R₄, R₅, R₆, R₇, R₈, R₉, R₁₀ and R₁₁ are each independently of the others hydrogen;
unsubstituted or substituted C₁-C₁₈alkyl or aryl; cyano; halogen; nitro; —COOR₁₂ or —SO₃R₁₂ wherein
R₁₂ is in each case hydrogen, a cation or unsubstituted or substituted C₁-C₁₈alkyl or aryl; —SR₁₃, —SO₂R₁₃ or —OR₁₃ wherein R₁₃ is in each case hydrogen or unsubstituted or substituted C₁-C₁₈alkyl or aryl; —NR₁₄R₁₅; —(C₁-C₆alkylene)-NR₁₄R₁₅; —N^{⊕}R₁₄R₁₅R₁₆; —(C₁-C₆alkylene)-N^{⊕}R₁₄R₁₅R₁₆;
—N(R₁₃)—(C₁-C₆alkylene)-NR₁₄R₁₅; —N[(C₁-C₆alkylene)-NR₁₄R₁₅]₂; —N(R₁₃)—(C₁-C₆alkylene)-N^{⊕}R₁₄R₁₅R₁₆;
—N[(C₁-C₆alkylene)-N^{⊕}R₁₄R₁₅R₁₆]₂; —N(R₁₃)—N—R₁₄R₁₅ or —N(R₁₃)—N^{⊕}R₁₄R₁₅R₁₆, wherein R₁₃ is as defined above and R₁₄, R₁₅ and R₁₆ are each independently of the other(s) hydrogen or unsubstituted or substituted C₁-C₁₈alkyl or aryl, or R₁₄ and R₁₅, together with the nitrogen atom linking them, form an unsubstituted or substituted 5-, 6- or 7-membered ring which may contain further hetero atoms, with the proviso that
at least one of the substituents R₁ to R₁₁ is a quaternised nitrogen atom that is not bonded directly to one of the three pyridine rings A, B or C.

16. A method according to claim 15, wherein
R₆ is C₁₂alkyl; phenyl unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy; cyano; halogen; nitro; —COOR₁₂ or —SO₃R₁₂ wherein R₁₂ is in each case hydrogen, a cation, C₁-C₁₂alkyl, unsubstituted phenyl or phenyl substituted as indicated above; —SR₁₃, —SO₂R₁₃ or —OR₁₃ wherein R₁₃ is in each case hydrogen, C₁-C₁₂alkyl, unsubstituted phenyl or phenyl substituted as indicated above; —NR₁₄R₁₅; —(C₁-C₆alkylene)-NR₁₄R₁₅; —N^{⊕}R₁₄R₁₅R₁₆; —(C₁-C₆alkylene)-N^{⊕}R₁₄R₁₅R₁₆;
—N(R₁₃)—(C₁-C₆alkylene)-NR₁₄R₁₅; —N(R₁₃)—(C₁-C₆alkylene)-N⊕R₁₄R₁₅R₁₆; —N(R₁₃)—N—R₁₄R₁₅ or —N(R₁₃)—N^{⊕}R₁₄R₁₅R₁₆, wherein R₁₃ may have any one of the above meanings and R₁₄, R₁₅ and R₁₆ are each independently of the other(s) hydrogen, unsubstituted or hydroxy-substituted C₁-C₁₂alkyl, unsubstituted phenyl or phenyl substituted as indicated above, or R₁₄ and R₁₅, together with the nitrogen atom linking them, form a pyrrolidine, piperidine, piperazine, morpholine or azepane ring which is unsubstituted or substituted by at least one unsubstituted C₁-C₄alkyl and/or substituted C₁-C₄alkyl, wherein the nitrogen atom may be quaternised, and R₁, R₂, R₃, R₄, R₅, R₇, R₈, R₉, R₁₀ and R₁₁ as defined in claim 15 or are hydrogen.

17. A method according to claim 15, wherein the ligand L′ is a compound of formula (3′) 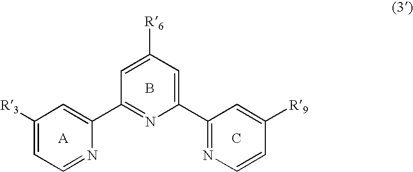
wherein
R′₃, R′₆ and R′₉ have the meanings given for R₆ in claim 15, but R′₃ and R′₉ may additionally be hydrogen.

18. A method according to claim 17, wherein
R′₃, R′₆ and R′₉ are each independently of the others phenyl unsubstituted or substituted by C₁-C₄alkyl, C₁-C₄alkoxy, halogen, phenyl or by hydroxy; cyano; nitro; —COOR₁₂ or —SO₃R₁₂ wherein R₁₂ is in each case hydrogen, a cation, C₁-C₄alkyl or phenyl; —SR₁₃, —SO₂R₁₃ or —OR₁₃ wherein R₁₃ is in each case hydrogen, C₁-C₄alkyl or phenyl; —N(CH₃)—NH₂ or —NH—NH₂; amino; N-mono- or N,N-di-C₁-C₄alkylamino unsubstituted or substituted by hydroxy in the alkyl moiety, wherein the nitrogen atoms may be quaternised;
N-mono- or N,N-di-C₁-C₄alkyl-N^{⊕}R₁₄R₁₅R₁₆ Unsubstituted or substituted by hydroxy in the alkyl moiety, wherein R₁₄, R₁₅ and R₁₆ are each independently of the others hydrogen, unsubstituted or hydroxy-substituted C₁-C₁₂alkyl, unsubstituted phenyl or phenyl substituted as indicated above, or R₁₄ and R₁₅, together with the nitrogen atom linking them, form a pyrrolidine, piperidine, piperazine, morpholine or azepane ring which is unsubstituted or substituted by at least one C₁-C₄alkyl or by at least one unsubstituted C₁-C₄alkyl and/or substituted C₁-C₄alkyl, wherein the nitrogen atom may be quaternised;
N-mono- or N,N-di-C₁-C₄alkyl-NR₁₄R₁₅ unsubstituted or substituted by hydroxy in the alkyl moiety, wherein R₁₄ and R₁₅ may be as defined above; or a radical 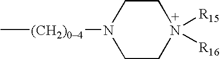
wherein R₁₅ and R₁₆ have the meanings given above, and the ring is unsubstituted or substituted, wherein R′₃ and R′₉ likewise may additionally be hydrogen.

19. A method according to claim 17, wherein R₆ is hydroxy.

20. A method according to claim 15, wherein at least one of the substitutents R₁ to R₁₁ is one of the radicals 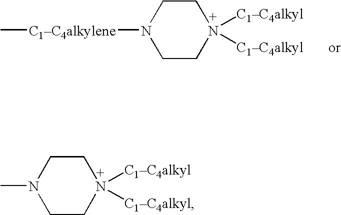
wherein the unbranched or branched alkylene group may be unsubstituted or substituted and wherein the alkyl groups, which are unbranched or branched independently of one another, may be unsubstituted or each independently of the others substituted and wherein the piperazine ring may be unsubstituted or substituted.

21. A method according to claim 15 wherein at least one of the substituents R₃, R′₃, R₆, R′₆, R₉ and/or R′₉, is one of the radicals 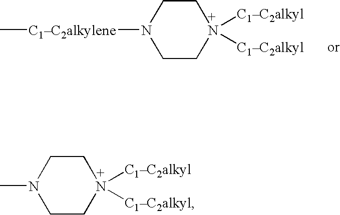
wherein the unbranched or branched alkylene group may be unsubstituted or substituted and wherein the alkyl groups, each independently of the others, may be unsubstituted or substituted and wherein the piperazine ring may be unsubstituted or substituted.

22. A method according to claim 1 for the bleaching of stains or of soiling on textile material, or for the prevention of redeposition of migrating dyes in the context of a hydrogen peroxide-free washing process, or for the cleaning of hard surfaces.

23. A method according to claim 1, wherein the metal complex compounds of formula (1) are used as catalysts for reactions using molecular oxygen and/or air for bleaching in the context of paper making.

24. A method according to claim 1, wherein the metal complex compounds of formula (1) are used in selective oxidation reactions in the context of organic synthesis.

25. A method according to claim 1, wherein the metal complex compounds of formula (1) are used in detergent, cleaning, disinfecting or bleaching compositions.

26. A method according to claim 25, wherein the metal complex compounds of formula (1) are formed in situ in the detergent, cleaning, disinfecting or bleaching composition.

27. A detergent, cleaning, disinfecting or bleaching composition containing
I) from 0 to 50% by weight A) of at least one anionic surfactant and/or B) one non-ionic surfactant,
II) from 0 to 70% by weight C) of at least one builder substance,
III) D) at least one metal complex compound of formula (1) as defined in claim 1 in an amount that, in the liquor, gives a concentration of from 0.5 to 100 mg/litre of liquor when from 0.5 to 20 g/litre of the detergent, cleaning, disinfecting or bleaching composition are added to the liquor, and
IV) water ad 100% by weight,
wherein the percentages are in each case percentages by weight, based on the total weight of the composition.

28. A solid formulation containing
a) from 1 to 99% by weight of at least one metal complex compound as defined in claim 1,
b) from 1 to 99% by weight of at least one binder,
c) from 0 to 20% by weight of at least one encapsulating material,
d) from 0 to 20% by weight of at least one further additive and also
e) from 0 to 20% by weight water.

29. A solid formulation according to claim 28, which is in the form of granules.
